(19) United States
(12) Patent Application Publication
(10) Pub. No.: US 2026/0319810 A1
(43) Pub. Date: Oct. 15, 2026

(54) OPTIMIZING CONFIGURATION OF THE ATTRIBUTION REPORTING APPLICATION PROGRAMMING INTERFACE

(71) Applicant: Google LLC, Mountain View, CA (US)

(72) Inventors: Matthew William Dawson, Thousand Oaks, CA (US); Badih Ghazi, Cupertino, CA (US); Harikesh Sasikumar Nair, Palo Alto, CA (US); Bo Luan, Mountain View, CA (US); Fangzhou Sun, Mountain View, CA (US); Nishanth Mundru, New York, NY (US); Shengyu Zhu, Cupertino, CA (US); Kapil Kumar, San Jose, CA (US); Vikas Kumar Singh, San Ramon, CA (US); Anurang Bhuta, Bangalore (IN); Wesley DeVore, Mountain View, CA (US)

(21) Appl. No.: 18/861,512

(22) PCT Filed: Jul. 23, 2024
(86) PCT No.: PCT/US2024/039166

§ 371 Date: Oct. 29, 2024

Related U.S. Application Data
(60) Provisional application No. 63/600,553, filed on Nov. 17, 2023.

(51) Int. Cl. G06F 9/445; G06F 11/30

(52) U.S. Cl. CPC G06F 9/44505; G06F 11/3072

(57) ABSTRACT

The disclosure generally describes methods, software, and systems for interaction data collection. A sensitivity level of an application programming interface for collecting interaction data is received. A maximum number of affirmative actions to be applied to the interaction data is received. The interaction data is converted to an affirmative action count. A scaling contribution is assigned to the affirmative action count to generate scaled data within particular units. The scaled data is aggregated by splitting the scaled data across multiple levels of an aggregate hierarchy of a targeted aggregate structure, to generate aggregated data. Noise is added to the aggregated data to generate noisy aggregated data. The noisy aggregated data is rescaled, using a scaling factor to generate rescaled data as aggregate summary reports, the aggregate summary reports being within a unit range set by the scaling factor. The rescaled data is transmitted to determine use cases.

### TECHNICAL FIELD

The present disclosure generally relates to computer-implemented methods, software, and systems for configuring attribution reporting application programming interfaces.

### BACKGROUND

Application programming interfaces (APIs) provide interfaces that can be used in computer applications to access other systems and associated functionality. In some instance, APIs can be used to collect and measure digital activity (in the form of interaction data) with respect to digital components provided by a platform (e.g., a content provider). The interaction data indicates user activity, such as clicks, in response to a presented information package (e.g., testing package, learning package, or other digital package). The interaction data can be collected and processed to generate reports that anonymize the interaction data, such as aggregate summary and event-level reports. The aggregate summary and event-level reports can be generated through data anonymization, aggregation, information truncation, and addition of noise to protect user privacy.

### SUMMARY

Implementations of the present disclosure are directed to techniques and tools for interaction data collection. More particularly, implementations of the present disclosure are directed to optimizing configuration of attribution reporting application programming interfaces for interaction data collection.

In some implementations, a method includes: receiving, by one or more processors from a configuration of an attribution reporting application programming interface (ARA), a sensitivity level of an application programming interface for collecting interaction data, the sensitivity level defining parameters of an interaction level monitored for collection of the interaction data, receiving, by the one or more processors from the configuration of the ARA, a maximum number of affirmative actions to be applied to the interaction data collected within the sensitivity level, the maximum number of affirmative actions defining a truncation applied to the affirmative actions, converting, by the one or more processors, the interaction data using the maximum number of affirmative actions to generate an affirmative action count, assigning, by the one or more processors, a scaling contribution to the affirmative action count to generate scaled data within particular units, aggregating, by the one or more processors, the scaled data by splitting the scaled data across a plurality of levels of an aggregate hierarchy of a targeted aggregate structure, to generate aggregated data, adding, by the one or more processors, noise to the aggregated data to generate noisy aggregated data, rescaling, by the one or more processors, the noisy aggregated data, using a scaling factor to generate rescaled data as aggregate summary reports, the aggregate summary reports being within a unit range set by the scaling factor, and transmitting, by the one or more processors, the rescaled data to determine use cases.

The present disclosure also provides a computer-implemented system including: memory storing application programming interface (API) information, and a server performing operations including: receiving, by one or more processors from a configuration of an attribution reporting application programming interface (ARA), a sensitivity level of an application programming interface for collecting interaction data, the sensitivity level defining parameters of an interaction level monitored for collection of the interaction data, receiving, by the one or more processors from the configuration of the ARA, a maximum number of affirmative actions to be applied to the interaction data collected within the sensitivity level, the maximum number of affirmative actions defining a truncation applied to the affirmative actions, converting, by the one or more processors, the interaction data using the maximum number of affirmative actions to generate an affirmative action count, assigning, by the one or more processors, a scaling contribution to the affirmative action count to generate scaled data within particular units, aggregating, by the one or more processors, the scaled data by splitting the scaled data across a plurality of levels of an aggregate hierarchy of a targeted aggregate structure, to generate aggregated data, adding, by the one or more processors, noise to the aggregated data to generate noisy aggregated data, rescaling, by the one or more processors, the noisy aggregated data, using a scaling factor to generate rescaled data as aggregate summary reports, the aggregate summary reports being within a unit range set by the scaling factor, and transmitting, by the one or more processors, the rescaled data to determine use cases.

The present disclosure also provides a non-transitory computer-readable media encoded with a computer program, the computer program including instructions that when executed by one or more computers cause the one or more computers to perform operations including: receiving, by one or more processors from a configuration of an attribution reporting application programming interface (ARA), a sensitivity level of an application programming interface for collecting interaction data, the sensitivity level defining parameters of an interaction level monitored for collection of the interaction data, receiving, by the one or more processors from the configuration of the ARA, a maximum number of affirmative actions to be applied to the interaction data collected within the sensitivity level, the maximum number of affirmative actions defining a truncation applied to the affirmative actions, converting, by the one or more processors, the interaction data using the maximum number of affirmative actions to generate an affirmative action count, assigning, by the one or more processors, a scaling contribution to the affirmative action count to generate scaled data within particular units, aggregating, by the one or more processors, the scaled data by splitting the scaled data across a plurality of levels of an aggregate hierarchy of a targeted aggregate structure, to generate aggregated data, adding, by the one or more processors, noise to the aggregated data to generate noisy aggregated data, rescaling, by the one or more processors, the noisy aggregated data, using a scaling factor to generate rescaled data as aggregate summary reports, the aggregate summary reports being within a unit range set by the scaling factor, and transmitting, by the one or more processors, the rescaled data to determine use cases.

The foregoing and other implementations can each optionally include one or more of the following features, alone or in combination. In particular, implementations can include all the following features. The sensitivity level and the maximum number of affirmative actions affect a balance between the data accuracy and data privacy. The computer-implemented method further includes: receiving, by the one or more processors from the configuration of the ARA, a many-per-click (MPC) limit defining a number of affirmative actions to be registered, and truncating, by the one or more processors, the affirmative actions using the MPC limit. The noise includes Laplace noise added to each data slice of the aggregated data. The noise is applied using a noising transformation that uses a set of summary statistics that index aspects of the affirmative action type. An increase of the scaling factor decreases the noise. The increase of the scaling factor is limited by a limit defined by the configuration of the ARA. The computer-implemented method further includes: using, by the one or more processors, the affirmative action count for training models of affirmative actions. The aggregate summary reports include hierarchically structured event-attributed affirmative action count as nodes distributed in a plurality of levels.

Other implementations of the aspect include corresponding systems, apparatus, and computer programs, configured to perform the actions of the methods, encoded on computer storage devices.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

Particular embodiments of the subject matter described in this specification can be implemented to realize one or more of the following advantages. The techniques described in this specification provide, improved quality of collected interaction data by optimizing configuration of attribution reporting application programming interfaces. In particular, service providers can configure attribution reporting application programming interfaces (ARA) to inject noise in a manner that preserves data privacy in a controlled manner that subsequently facilitates analysis on the underlying data. Traditional APIs did not include configurable ARAs as described and third party cookie frameworks provided a limited level of control on data collection and subsequent analysis. Overcoming the limitations of traditional systems, the described approach provides access to the ARA configuration to collect and process interaction data that facilitates prioritization of parameters relevant to a usage of the interaction data. The interaction data collection parameters include interrelated parameters, such as a sensitivity level of an application programming interface for collecting interaction data and a maximum number of affirmative actions to be applied to the interaction data collected within the sensitivity level. The selection of the interrelated parameters (the sensitivity level and of the maximum number of affirmative actions) involves an explicit tradeoff between truncation (e.g., affirmative action coverage) and noise (e.g., accuracy), such that a reduction of one of the interrelated parameters increases the other parameter. The noise can also be controlled by using an assignment of a scaling contribution to the affirmative action count to generate scaled data within particular units. Advantageously, the effective amount of noise is determined by the adjustable scaling factor, such that a larger scaling factor has a smaller effective amount of noise applied to the affirmative action count.

As another advantage, the scaled data can be split across multiple levels of an aggregate hierarchy of a targeted aggregate structure, to generate aggregated data. The aggregated data can be generated as a tree of aggregates, for which the signal to noise ratio of its nodes is within acceptable and useful limits relative to targeted use cases. By allocating more sensitivity budgets to some nodes of the original aggregate tree, the respective nodes are less noisy, and in turn, the shape of the useful tree is adjusted. The described aggregation adjustment can be implemented in conjunction with the sensitivity level adjustment tool to determine a width and a depth of a useful aggregate tree. As described, the presented approach enables setting of the sensitivity level and of the maximum number of affirmative actions, in addition to other operations used for generating aggregate summary reports that have a high impact on accuracy of the rescaled data applicable to determine use cases and can be adjusted in order to maximize data utility.

As another advantage, adaptation of data collection to multiple types of API configurations can enable flexibility of technology integration. The generation of statistical data including interaction measurements and consumption of the statistical data can be faster than in conventional systems, in which separate different protocols are applied. The generation of statistical data by merging event-level data and aggregated summary reports increases an accuracy of the interaction measurements, by leveraging the combined use of the API data that provides better measurement fidelity than using either report type in isolation. Along with the interaction data, the configuration of attribution reporting application programming interfaces enables selection of additional collectable information associated with the interaction. The configuration of attribution reporting application programming interfaces protects user privacy, by generating interaction data reports based on conversions including a combination of data anonymization, data aggregation, information truncation, and addition of noise. To further protect user privacy, limits are set on how much metadata can be extracted from the conversions.

The details of one or more implementations of the subject matter of the specification are set forth in the accompanying drawings and the description below. Other features, aspects, and advantages of the subject matter can become apparent from the description, the drawings, and the claims.

### DESCRIPTION OF THE DRAWINGS

The accompanying drawings, which are incorporated in and constitute a part of this specification, show particular aspects of the subject matter disclosed herein and, together with the description, help explain some of the principles associated with the disclosed implementations. In the drawings,

FIG. 1 is a block diagram of an example system that can be used to execute implementations of the present disclosure.

FIG. 2 is a block diagram of another example system, according to some implementations of the present disclosure.

FIG. 3A depicts a flowchart of an example process, according to some implementations of the present disclosure.

FIG. 3B depicts a flowchart of another example process, according to some implementations of the present disclosure.

FIG. 4A depicts a schematic diagram illustrating an example three-click model, in accordance with some example implementations.

FIG. 4B depicts a schematic diagram illustrating example click-conversion scenarios, in accordance with some example implementations.

FIG. 5A depicts a schematic diagram illustrating an example aggregate summary report, in accordance with some example implementations.

FIG. 5B depicts a schematic diagram illustrating an example event level report, in accordance with some example implementations.

FIG. 6 is a block diagram of an example tree, in accordance with some example implementations.

FIGS. 7A-7C depict example plots, in accordance with some example implementations.

FIG. 8 depicts an example distribution conversion count graph, in accordance with some example implementations.

FIG. 9 depicts an example comparison graph, in accordance with some example implementations.

FIG. 10 depicts an example result graph, in accordance with some example implementations.

FIG. 11 depicts a block diagram illustrating a computing system, in accordance with some example implementations.

When practical, like labels are used to refer to same or similar items in the drawings.

### DETAILED DESCRIPTION

Implementations of the present disclosure are directed to techniques and tools for interaction data collection. More particularly, implementations of the present disclosure are directed to optimizing configuration of attribution reporting application programming interfaces (ARA) for interaction data collection. The configuration of ARA can define interrelated parameters for collection of interaction data and conversion factors applied to the collected interaction data. The flexible nature of ARA configuration facilitates a variety of measurement use-cases across a rich diversity of technologies and target associated services. The described ARA configuration also facilitates setting and adjustment of the interrelated parameters, relative to particular use cases of interest, to preserve privacy of interaction data and to allow introduction of noise in generated reports that allows for noise removal and generation of data relevant for use cases.

The described ARA configuration imposes a tradeoff between noise (e.g., accuracy), and data truncation (e.g., affirmative action coverage) through the selection of the interrelated parameters (collection of interaction data and conversion factors). For example, ARA configuration facilitates a definition of the collection parameters including a sensitivity level of an application programming interface for collecting interaction data. The sensitivity level limits data collection to a particular type of interaction data, affecting an overall number of collected interaction data. The interaction data can include service associated interactions (e.g., user input, such as a click received in response to an indication of an available service), service-views (e.g., user views of the indication of the available service for a particular duration), service-group (e.g., grouping of services that share similar targeting settings), service-technology (e.g., technology company which provides services, such as testing, learning, or other digital services and derive statistical data to optimize a service-protocol). A service-campaign includes a set of software-defined protocols for generating a set of service-groups (e.g., service types, keywords, and bids) that share common settings (e.g., location targeting, user group target, and other settings). Campaigns can be used to organize categories of items (e.g., products) or services that a provider (e.g., tester or service provider) provides.

The conversion factors applied to the collected interaction data define a maximum number of affirmative actions to be applied to the interaction data collected within the sensitivity level. The conversion factors that can be stored by the ARA configuration can include limiting parameters applicable to respective operation types (e.g., conversion, scaling, aggregation, and rescaling) to be applied to collected interaction data to generate reports that allow for noise removal and generation of data relevant for use cases. For example, a scaling operation can be applied, according to ARA settings, to the interaction data, using an adjustable scaling contribution that controls the noise included within particular units of the generated scaled data. The effective amount of noise is determined by the adjustable scaling factor, such that a larger scaling factor provides a smaller effective amount of noise applied to the affirmative action count. The ARA settings can also define parameters of a scaling operation to generate scaled data that can be split across multiple levels of an aggregate hierarchy of a targeted aggregate structure, to generate aggregated data. The ARA settings can also define parameters of the targeted aggregate structure, such that the aggregated data can be generated as a tree of aggregates, for which the signal to noise ratio of its nodes is within acceptable and useful limits relative to targeted use cases. By allocating more sensitivity budgets to some nodes of the original aggregate tree, the respective nodes are less noisy, and in turn, the shape of the useful tree is adjusted. The ARA settings can also define parameters that can also define rescaling parameters that include a scaling factor used to generate rescaled data as aggregate summary reports. The described ARA configuration adjustment can be implemented to increase an accuracy of the rescaled data relative to use cases and to maximize data utility.

The ARA configuration can be used for generating two types of reports from the collected interaction data. The reports include event level reports and aggregated summary reports. The event level reports include filtered interaction event data corresponding to interaction-events generated according to multiple conversion types that can be reported in a truncated format. For example, the event level reports can include tabular structured data (e.g., data tables) including interaction identifiers, associated service identifiers, affirmative action count types, and affirmative action count values per each interaction count type. Event level reports are received from application programming interfaces (APIs) of different source system that can have different ways to expose metadata corresponding to APIs and events. The aggregated summary reports include data aggregates generated by grouping converted data including event-attributed affirmative action data that is aggregated as data slices at one or more levels. The aggregated summary reports are configured based on a pre-definition of the slices, over which an interaction provider system plans to learn about event-attributed affirmative action activity. For example, the aggregated summary reports can include hierarchical structured data including a parent node and one or more child nodes, each node including a key corresponding to an associated service identifier, an affirmative action type, and a number of aggregated affirmative action count values per each node. The event-level and aggregated summary reports represent two different views of the same underlying interaction data. The nature of the data generated by both is a function of how each transforms the same underlying data to preserve user privacy. The described process includes a derivation of interaction activity measurement based on applied data privacy transformations. For example, the described technology considers two aspects of working with the API data: conversion truncation and noise considerations, and how these aspects differ for each of the API, according to respective configurations. The term “event” in event-level reports corresponds to interaction-events. That is, the event-level reports include a report with a granularity defined by an interaction, such as a click or a view.

Essentially ARA configuration is the answer to “what data should I query, and how should I query it?” The ARA configuration provides a secure control of querying data that preserves user privacy. In particular, the ARA configuration facilitates interaction measurement in a privacy-preserving way, without third-party cookies. The third-party cookies include a set of digital identifiers that maintain a persistent identity state for a browser across visited sites. In some cases, third-party cookies use nested scripts to avoid detection of interaction data tracking and uncontrolled data collection settings that raise privacy and system security issues. In contrast to third-party interaction data tracking, the described implementations enable control of data privacy and system security through ARA configuration settings that facilitate an adjustment of configuration settings for collection of interaction data. The ARA configuration can provide a differential privacy defining a framework for extracting useful information from a dataset, while providing protection against leakage of information corresponding to entities in the dataset. The ARA configuration implements differential privacy by protecting the information that can be extracted from the two types of generated reports.

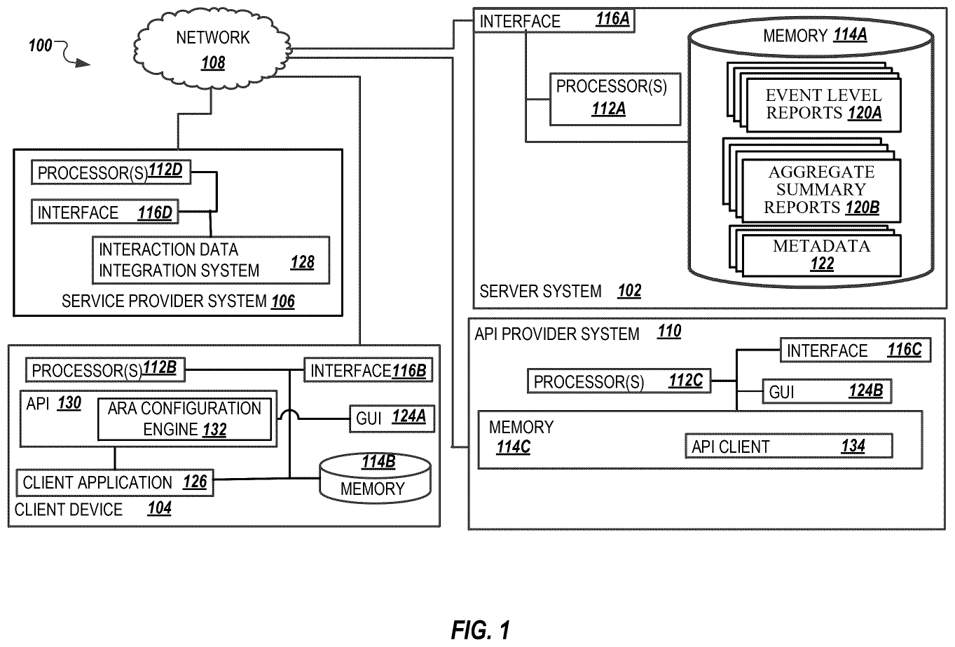

The described technologies for optimizing ARA configuration address several new data collection and processing-related issues that were previously not present with third-party cookies (3PC). The issues arise from the changes introduced by the API data for protecting data privacy. Due to anonymization, aggregation, information truncation and addition of noise, the data reported to content provider systems by the API can deviate from the affirmative action data measured by 3PCs (henceforth 3PC conversions). Using adjustable ARA configurations, event-level reports and summary reports can be generated to protect data privacy, by introducing a controlled noise-level while facilitating derivation of data relevant for use case analysis. The configurable settings of the aggregate summary reports include many-per-click (MPC) limit and sensitivity budget allocation, which are described in detail with reference to FIGS. 1-11.

FIG. 1 is a block diagram of an example system that can be used to execute implementations of the present disclosure. The example system 100 is used for setting ARA configuration. The illustrated example system 100 includes or is communicably coupled with a server system 102, a client device 104, a service provider system (and/or asset provider systems) 106, an API provider system 110, and a network 108. Although shown separately, in some implementations, functionality of two or more systems or servers can be provided by a single system or server. In some implementations, the functionality of one illustrated system, server, or component can be provided by multiple systems, servers, or components, respectively.

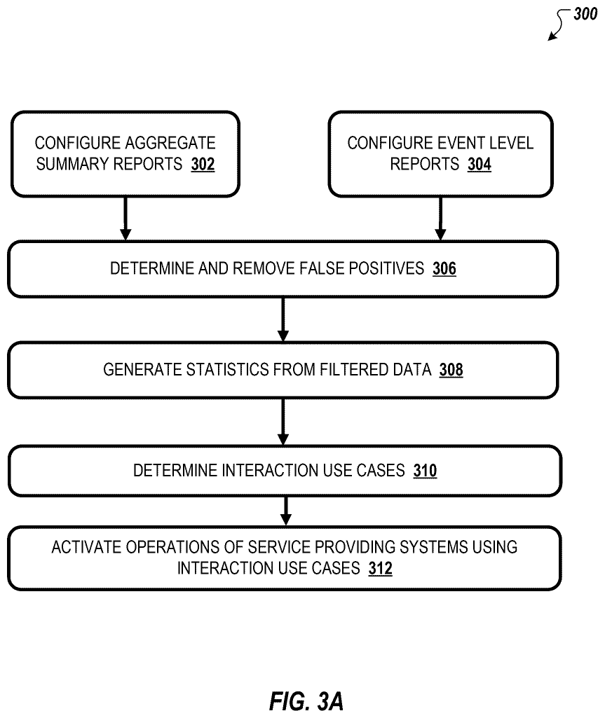

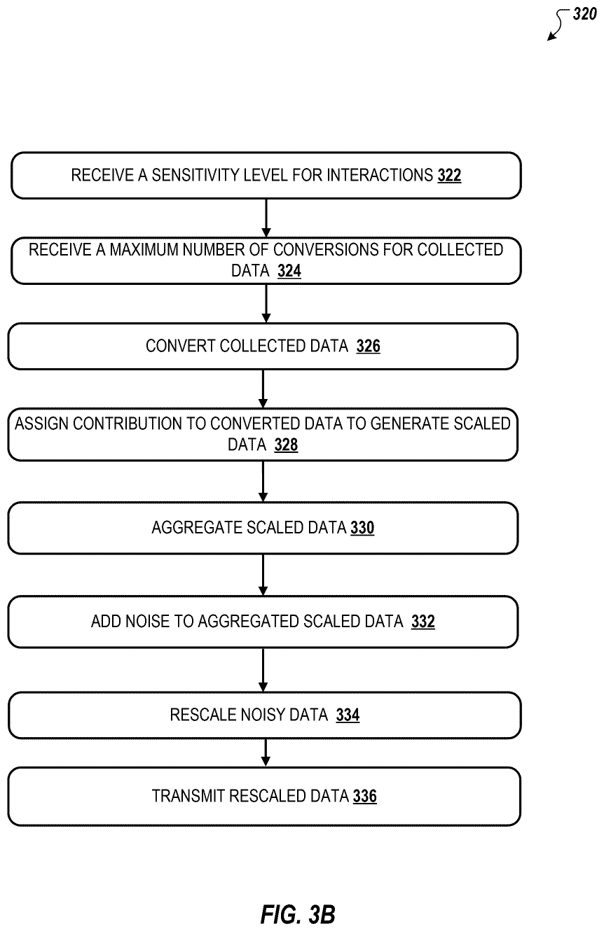

In the example of FIG. 1, the server system 102 is intended to represent various forms of servers including, but not limited to a web server, an application server, a proxy server, a network server, and/or a server pool. In general, server systems 102 accept requests for application services, such as testing services, interaction services, experimental services, and provides such services to any number of client devices 104 (e.g., the client device 104 over the network 108). In accordance with implementations of the present disclosure, and as noted above, the server system 102 can host a solution environment that can be a cloud environment providing software applications, systems, and services, such as content display on client devices 104 within applications that can be consumed by entities as a service. The interaction generated in response to the provided service can be measured and can be provided to content provider systems (and/or asset provider systems) 106. In some instances, the server system 102 can support configuring APIs of different types, as well as services of different types that are integrated in user privacy settings (scenarios) and support execution of processes, as described with reference to FIGS. 3, 5, 8, and 10A-10C.

The server system 102 includes a processor 112A, a memory 114A and an interface 116A. The memory 114A can include event level reports 120A, aggregated summary reports 120B, and metadata 122. The event level reports 120A, aggregated summary reports 120B can include documents defining events (e.g., interactions with user interfaces) recorded by resources (APIs) provided by API provider system(s) 110. The metadata 122 provides additional information related to service-interactions and/or conversions. In some implementations, metadata 122 can include encoded data pointing to API configurations (e.g., defining conversion types applied by respective APIs).

The client device 104 and the API provider system 110 can each be any computing device operable to connect to or communicate in the network(s) 108 using a wireline or wireless connection. In general, each of the client device 104 and the API provider system 110 includes an electronic computer device operable to receive, transmit, process, and store any appropriate data corresponding to the system 100 of FIG. 1. Each of the client device 104 and the API provider system 110 is generally intended to encompass any computing device such as a laptop/notebook computer, wireless data port, smart phone, personal data assistant (PDA), tablet computing device, one or more processors within these devices, or any other suitable processing device. The client device 104 and the API provider system 110 respectively include interface(s) 116B, 116C, processor(s) 112B, 112C, memories 114B, 114C, and graphical user interface(s) (GUIs) 124A, 124B.

The client device 104 can include one or more client applications 126. The client application 126 can be any type of application that allows a client device to request and view content on the client device (e.g., internet browsers). In some implementations, a client application 126 can be corresponding to an API 130 that can collect user data, metadata, and other API event information according to parameters set by the ARA configuration engine 132. The settings of the ARA configuration engine 132 are applied to interaction data collection and processing to preserve user privacy data (event level reports 120A, aggregated summary reports 120B). The ARA configuration engine 132 can be included in the API 130, as shown in FIG. 1. The ARA configuration engine 132 can be a part of a privacy tool (e.g., Privacy Sandbox by Google L.L.C.) associated to a client application 126 (e.g., internet browsers). In some instances, the client application 126 can be an agent or client-side version of the one or more enterprise applications running on an enterprise server (not shown). The memory 114C of the target API provider system 110 can include an API client 134 that can be used for integration dependency.

The client device 104 and/or the API provider system 110 can comprise a computer that includes an input device, such as a keypad, touch screen, or other device that can accept user information, and an output device that conveys information corresponding to the operation of the server 102, or the client device itself, including digital data, visual information, or a GUI 124A, 124B, respectively. The GUI 124A, 124B each interface with at least a portion of the system 100 for any suitable purpose, including generating a visual representation of the client application 126 or the administrative application 133, respectively. In particular, the GUIs 124A, 124B can each be used to view and navigate various Web pages. Generally, the GUIs 124A, 124B each provide the user with an efficient and user-friendly presentation of object data (metadata) provided by or communicated within the system. The GUIs 124A, 124B can each comprise a plurality of customizable frames or views having interactive fields, pull-down lists, and buttons operated by the user during recordable events that can be included in API collected data (e.g., event level reports 120A, aggregated summary reports 120B). The GUIs 124A, 124B each contemplate any suitable graphical user interface, such as a combination of a generic web browser, intelligent engine, and command line interface (CLI) that processes information and efficiently presents the results to the user visually.

The content provider systems (and/or asset provider systems) 106 can include multiple systems that exist in a multi-system landscape. An organization can use different systems, of different types, to run the organization, for example. The content provider systems (and/or asset provider systems) 106 can include systems from a same entity or different entities. The content provider systems (and/or asset provider systems) 106 can each include at least one of an interface 116D, a processor 112D, and an interaction data integration system 128. The interaction data integration system 128 can include an implementation of operations associated to statistical data indicative of interaction measurements. The operations implementation capabilities include a set of criteria to select and trigger automatic implementation of an operation based on the statistical event-attributed data. The interaction data integration system 128 can filter the entity landscape to identify suitable operation target, from multiple asset provider systems 106, based on API configurations and can automatically select an identified API provider systems 110 for establishing connections to any of the client device 104 and/or the API provider system 110, over the network 108.

In some implementations, the network 108 can include a large computer network, such as a local area network (LAN), a wide area network (WAN), the Internet, a cellular network, a telephone network (PSTN) or an appropriate combination thereof connecting any number of communication devices, mobile computing devices, fixed computing devices and server systems. Data exchanged over the network 108, is transferred using any number of network layer protocols, such as Internet Protocol (IP), Multiprotocol Label Switching (MPLS), Asynchronous Transfer Mode (ATM), Frame Relay, etc. Furthermore, in implementations where the network 108 represents a combination of multiple sub-networks, different network layer protocols are used at each of the underlying sub-networks. In some implementations, the network 108 represents one or more interconnected internetworks, such as the public Internet.

Each processor 112A, 112B, 112C, 112D included in the client device 104, content provider systems (and/or asset provider systems) 106, or the API provider system 110 can be a central processing unit (CPU), an application specific integrated circuit (ASIC), a field-programmable gate array (FPGA), or another suitable component. Generally, each processor 112A, 112B, 112C, 112D included in the client device 104 or the API provider system 110 executes instructions and manipulates data to perform the operations of the client device 104 or the API provider system 110, respectively. Specifically, each processor 112A, 112B, 112C, 112D included in the client device 104 or the API provider system 110 executes the functionality used to send requests to the server 102 and to receive and process responses from the server 102. Each processor 112A, 112B, 112C, 112D can be a central processing unit (CPU), a blade, an application specific integrated circuit (ASIC), a field-programmable gate array (FPGA), or another suitable component. Each processor 112A, 112B, 112C, 112D executes instructions and manipulates data to perform the operations of the respective system (the server system 102, the client device 104, the API provider system 110, and the content provider systems (and/or asset provider systems) 106). Specifically, each processor 112A, 112B, 112C, 112D executes the functionality used to receive and respond to requests from the respective system (the server system 102, the client device 104, the API provider system 110, and the content provider systems (and/or asset provider systems) 106), for example.

Interfaces 116A, 116B, 116C, 116D are used by the server 102, the client device 104, the service provider system 106, and the API provider system 110, respectively, for communicating with other systems in a distributed environment—including within the system 100—connected to the network 108. Generally, the interfaces 116A, 116B, 116C, 116D each include logic encoded in software and/or hardware in a suitable combination and operable to communicate with the network 108. More specifically, the interfaces 116A, 116B, 116C, 116D can each include software supporting one or more communication protocols corresponding to communications such that the network 108 or interface's hardware is operable to communicate physical signals within and outside of the illustrated system 100.

The memory 114A, 114B, 114C can include any type of memory or database engine and can take the form of volatile and/or non-volatile memory including, without limitation, magnetic media, optical media, random access memory (RAM), reservice-only memory (ROM), removable media, or any other suitable local or remote memory component. The memory 114A, 114B, 114C can store various objects or data, including caches, classes, frameworks, applications, backup data, objects, jobs, web pages, web page templates, database tables, database queries, repositories storing entity information and/or dynamic information, and any other appropriate information including any parameters, variables, algorithms, instructions, rules, constraints, or references thereto corresponding to the purposes of the server system 102, the client device 104, the API provider system 110, or the service provider system 106, respectively.

There can be any number of client devices 104 and API provider systems 110 corresponding to, or external to, the system 100 for collecting and processing interaction event data. Additionally, there can also be one or more additional client devices external to the illustrated portion of system 100 that are capable of interacting with the system 100 via the network(s) 108. Further, the term “client,” “client device,” and “user” can be used interchangeably as appropriate without departing from the scope of the disclosure. Moreover, while client device can be described in terms of being used by a single user, the disclosure contemplates that many users can use one computer, or that one user can use multiple computers. As used in the present disclosure, the term “computer” is intended to encompass any suitable processing device. For example, although FIG. 1 illustrates a single server 102, a single client device 104, a single API provider system 110, the system 100 can be implemented using a single, stand-alone computing device, two or more servers 102, or multiple client devices. The server system 102, the client device 104 and the API provider system 110 can include any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the server 102 and the client device 104 and the API provider system 110 can be adapted to execute any operating system or runtime environment, including Linux, UNIX, Windows, Mac OS®, Java™, Android™, iOS, BSD (Berkeley Software Distribution) or any other suitable operating system. According to one implementation, the server 102 can also include or be communicably coupled with an e-mail server, a Web server, a caching server, a streaming data server, and/or another suitable server.

Regardless of the particular implementation, “software” can include computer-readable instructions, firmware, wired and/or programmed hardware, or any combination thereof on a tangible medium (transitory or non-transitory, as appropriate) operable when executed to perform at least the processes and operations described herein. Indeed, each software component can be fully or partially written or described in any appropriate computer language including C, C++, Java™, JavaScript®, Visual Basic, assembler, Perl®, ABAP (Advanced Business Application Programming), ABAP OO (Object Oriented), any suitable version of fourth-generation programming language, as well as others. While portions of the software illustrated in FIG. 1 are shown as individual engines that implement the various features and functionality through various objects, methods, or other processes, the software can instead include multiple sub-engines, third-party services, components, libraries, and such, as appropriate. Conversely, the features and functionality of various components can be combined into single components as appropriate.

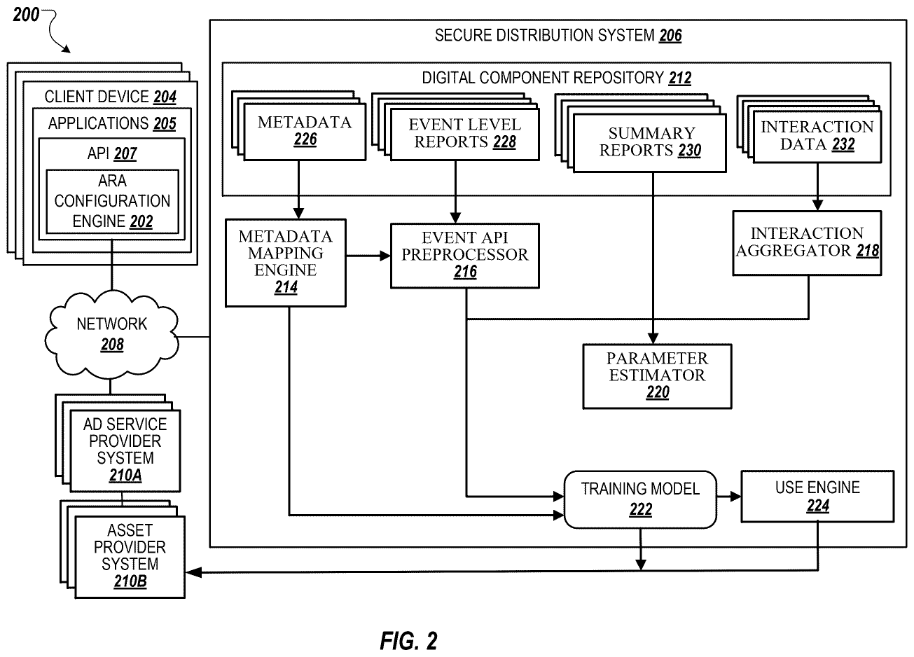

FIG. 2 is a block diagram of another example system, according to some implementations of the present disclosure. The example system 200A includes a system for secure collection and distribution of interaction data using an ARA configuration engine 202. The illustrated example system 200 includes or is communicably coupled with a client device 204, a secure distribution system 206, network 208, a content provider system 210A, and an asset provider system 210B.

The client device 204 can include applications 205, such as web browsers and/or native applications, to facilitate the sending and receiving of data over the network 208. A native application is an application developed for a particular platform or a particular device (e.g., mobile devices having a particular operating system). Although operations can be described as being performed by the client device 204, such operations can be performed by an application 205 running on the client device 204. The applications 205 can present electronic resources, e.g., web pages, application pages, or other application content, to a user of the client device 204. The electronic resources can include digital component slots for presenting digital components with the content of the electronic resources. A digital component slot is an area of an electronic resource (e.g., web page or application page) for displaying a digital component. A digital component slot can also refer to a portion of an audio and/or video stream (which is another example of an electronic resource) for playing a digital component.

An electronic resource is also referred to herein as a resource for brevity. For the purposes of the document, a resource can refer to a web page, application page, application content presented by a native application, electronic document, audio stream, video stream, or other appropriate type of electronic resource with which a digital component can be presented. As used throughout the document, the phrase “digital component” refers to a discrete unit of digital content or digital information (e.g., a video clip, audio clip, multimedia clip, image, text, or another unit of content). A digital component can electronically be stored in a physical memory device as a single file or in a collection of files, and digital components can take the form of video files, audio files, multimedia files, image files, or text files and include interaction information, such that an interaction is a type of digital component. For example, the digital component can be content that is intended to supplement content of a web page or other resource presented by the application 205. More specifically, the digital component can include digital content that is relevant to the resource content (e.g., the digital component can relate to the same topic as the web page content, or to a related topic). The provision of digital components can supplement, and generally enhance, the web page or application content.

In response to the application 205 loading a resource that includes a digital component slot, the application 205 can generate a digital component request 225 that requests a digital component for presentation in the digital component slot. In some implementations, the digital component slot and/or the resource can include code (e.g., scripts) that cause the application 205 to request a digital component from the content provider system 210A that can be recorded by the API 207, according to data collection settings defined by the ARA configuration engine 202, as interaction data.

The interaction data collected by the API 207 can be processed using one or more operations, according to data collection settings defined by the ARA configuration engine 202, to generate user interaction reports. The reports include data related to the client device 204 and/or non-sensitive data, such as query strings. The interaction data can be grouped based on different criteria, including services associated to the interactions and/or parameters of the client device 204.

The client device 204 can include controls (e.g., user interface elements with which a user can interact) allowing the user to provide a user input that can be recorded as a user interaction. For example, the client device 204, the applications 205, and the APIs 207 can facilitate collection of user information (e.g., information about a user's social network, social actions, or activities, profession, a user's preferences, or a user's current location), according to data collection settings defined by the ARA configuration engine 202. The ARA configuration, set and adjusted using the by the ARA configuration engine 202, can include data collection parameters and conversion parameters defining operations applied to interaction data to generate reports, such as the event level reports 228 and summary reports 230. For example, according to the configuration of ARA, conversion of the interaction data can be defined according to conversion attribution, conversion type, and conversion value. The conversion attribution includes an assignment of a conversion activity to an appropriate prior service-interaction(s). The conversion type includes a description of the conversion, such as user interaction results (e.g., purchase of an item, a page view, subscription, etc.). The conversion value includes a value to the service provider of a conversion, typically expressed in currency units. The conversion data includes user actions relevant for a service provider, such as a visit or interaction with a website, which service-techs report and optimize for on behalf of asset providers. The conversion data and other data extracted from the interaction data are included in reports generated according to ARA configuration. In addition, interaction data can be processed in one or more ways, according to data processing settings defined by the ARA configuration engine 202, before it is transmitted to be stored, by the digital component repository 212 of the secure distribution system 206 or used, so that personally identifiable information is truncated (at least partially removed) and noise is added to hide private user data. For example, private data can be truncated so that no personally identifiable information can be determined, or a geographic location can be generalized where location information is obtained (such as to a city, ZIP code, or state level), so that a particular location of the device cannot be determined. The user can have control over the settings of the ARA configuration engine 202 defining what information is collected about the user, how that information is used, and what information is provided to the content provider system 210A and the asset provider system 210B.

Interaction event data, recorded by the API 207, can also include contextual data, which is generally considered non-sensitive. The contextual data can describe the environment, in which a selected digital component was presented. The contextual data can include, for example, coarse location information indicating a general location of the client device 204 that sent the digital component request, a resource (e.g., website or native application) with which the selected digital component can be presented, a spoken language setting of the application 205 or client device 204, the number of digital component slots, in which digital components are presented with the resource, the types of digital component slots, and other appropriate contextual information.

The secure distribution system 206 can be included in a server system (e.g., server system 102 described with reference to FIG. 1). Although shown separately, in some implementations, the secure distribution system 206 can be included in any of the client device 204 (e.g., client device 104 described with reference to FIG. 1), the content provider systems 210A (e.g., system 106 described with reference to FIG. 1), or the asset provider system 210B (e.g., system 106 described with reference to FIG. 1) or can be communicatively coupled over the network 208 (e.g., network 108 described with reference to FIG. 1) to any of the client device 204, the content provider system 210A, and the asset provider system 210B. The secure distribution system 206 can be implemented using one or more server computers (or other appropriate computing devices), that can be distributed across multiple locations. In general, the secure distribution system 206 receives requests for digital components from client devices 204, selects digital components based on data included in the requests, and sends the selected digital components to the client devices 204. In some implementations, the secure distribution system 206 can be operated and maintained by an independent trusted party, e.g., a party that is different from the users of the client devices, the parties that operate supply side platform (SSP) and demand side platforms (DSPs), and the digital component providers, to ensure security and privacy with respect to the data. For example, the secure distribution system 206 can be operated by an industry group or a governmental group.

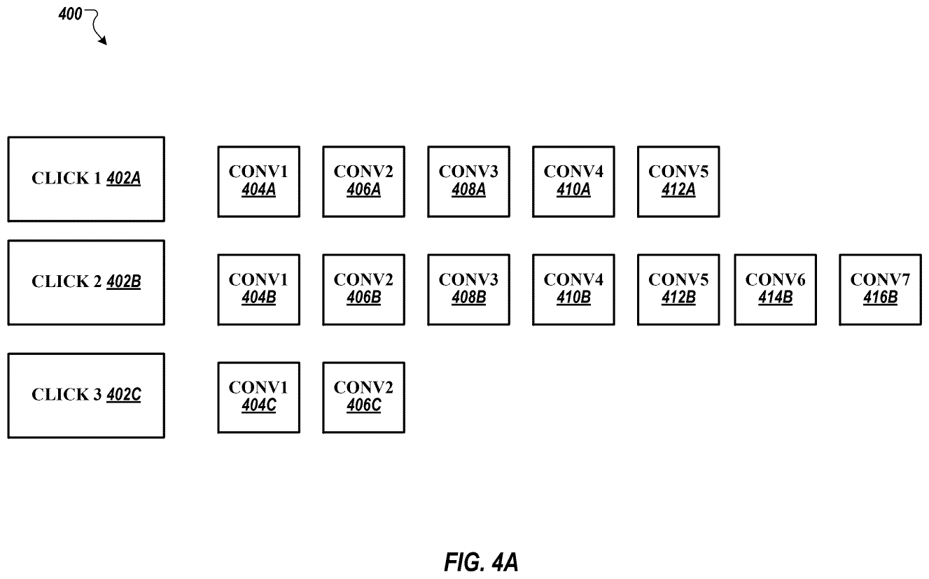

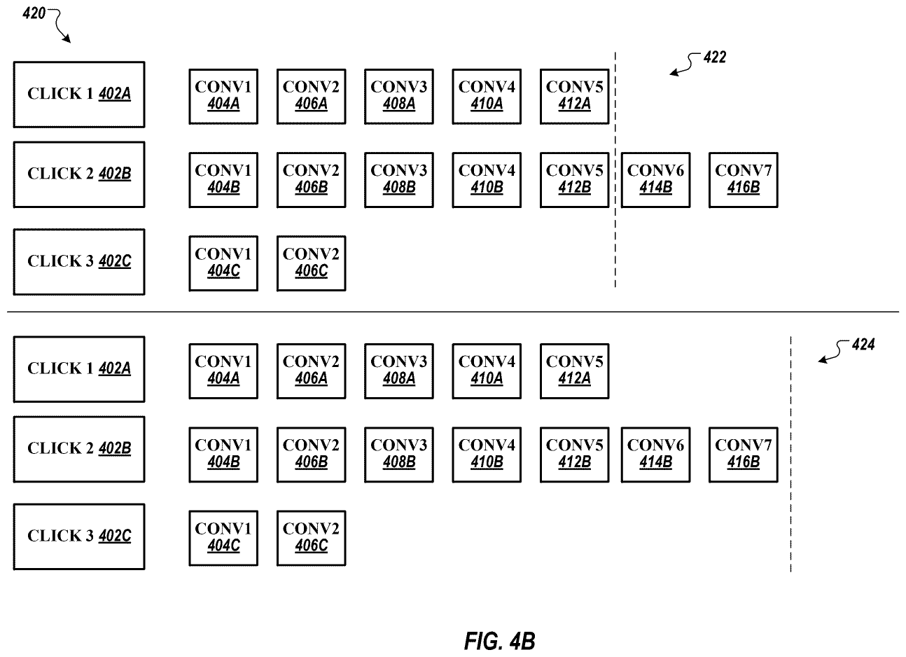

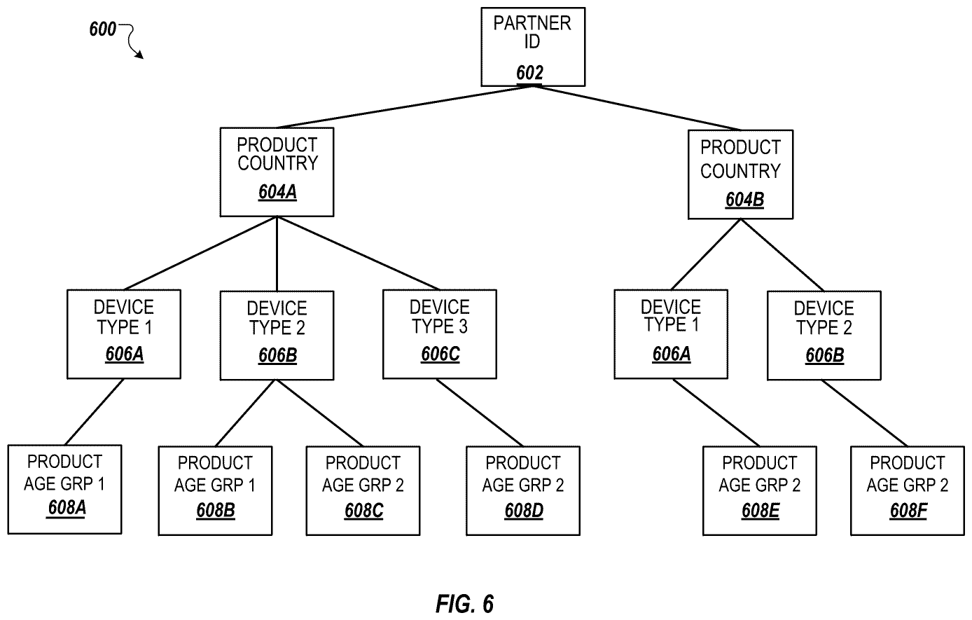

The secure distribution system 206 can include a digital component repository 212, a metadata mapping engine 214, an event API preprocessor 216, an interaction aggregator 218, a parameter estimator 220, a deep biasing engine 222, and an interaction use engine 224. The digital component repository 212 can be a database configured to store data including data received from API such as metadata 226, event level reports 228, summary reports 230, and interaction data 232. The event level reports 228 and the summary reports 230 can include eventified and modeled data logs, which reflect the same information content in two types of reports that provide different levels of granularity (one more detailed, and one more in summary form). As described with reference to FIGS. 4A-4C and 6A and 6B, the event level reports 228 and the summary reports 230 include tabulated logs with rows representing interaction-events and columns representing the outcomes (affirmative action counts and associated values) attributed to the interaction-events.

The metadata mapping engine 214 can access (obtain or retrieve) the metadata 226 from the digital component repository 212 and provide an output of metadata processing to the event API preprocessor 216. The metadata mapping engine 214 can filter out some conversions by looking up a metadata mapping table that can be stored by the digital component repository 212. If the metadata 226 for an identified log entry is not registered inside the metadata mapping table, it is determined that the conversion of the log entry is on the fake branch.

The event API preprocessor 216 can be configured to process the input received from the metadata mapping engine to 214 and event level reports 228 retrieved from the digital component repository 212 to generate an output that is provided to the parameter estimator 220 and the training engine 222. The interaction aggregator 218 can access (obtain or retrieve) the interaction data 232 from the digital component repository 212 and provide an output of interaction data processing to the parameter estimator 220.

The training engine 222 can include a training model and/or a data process pipeline using a log aggregator (e.g., Flume C++) and a protocol buffer. The training engine 222 can include a debiasing layer to regularly run the pipeline and to generate debiased event API data by processing the inputs received from the event API preprocessor 216 and the parameter estimator 220. For example, the data derived, by the event API preprocessor 216, from the event-level reports 228, can be processed, by the training engine 222, using aggregate information derived from the aggregated summary reports 230 to recover the underlying third-party cookies (3PC) conversions applied to the interaction data, while retaining the event-level nature of the interaction data. Because of the privacy protection nature of the API, the recovered data is not identical to the event-level 3PC affirmative action data, but the output of the training engine 222 includes an actionable event-level data log that nevertheless be used for interaction use-cases, by the interaction use engine 224.

In some implementations, the training engine 222 performs a post mapping process based on (trainable) machine learning models, which map the conversion metadata value to conversion types or biddability information. The machine learning models can be trained using as input a training dataset with units of interaction-events and attributed conversion (or conversion values) combinations, matching the structure of the eventified logs. Building both the reporting and the offer generation (e.g., bidding to a group of service providers) off the same log can reduce processing complexity and automatically provides consistency across use-cases. For example, the training engine 222 can be used to train a machine learning model on the denoised aggregates and the event-level report data to predict values for the eventified log, resulting in a trained model. The conversions (or conversion values) can be provided to the training system as input features, and the interaction-event characteristics contain values that can be provided to the training system as target outputs. The training engine 222, during training phase, can select the type of machine learning model to be trained, e.g., pick a predefined or default type of machine learning model, or analyze the input features and the target outputs to identify a particular type of machine learning model. For example, types of machine learning models can include a gradient boosted trees model, a generalized linear model, a support vector machine, a decision tree model, or a neural network model, e.g., a multilayer perceptron (MLP). The machine learning models can be trained using machine learning training algorithms such as minimizing an error, computing a gradient, or performing backpropagation. In some implementations, the training system can use the metadata corresponding to denoised aggregates and the event-level report data to preprocess the values of the interaction-event characteristics to provide to the training system. For example, by using metadata that identifies the type of data for the values, the system can preprocess the values so that the training system can more accurately interpret the values. In other words, the training system can map the conversion values in the cell into encoded representations that can be provided as input features for the training of the machine learning model. For example, the system can convert each pair of denoised aggregates and the event-level report data to predict values for the eventified log in a format that the content provider system 210A and/or the asset provider system 210B can interpret, such as for use cases that can be identified by the interaction use engine 224.

The debiased data is sent to the interaction use engine 224 and, optionally, to the content provider system 210A and the asset provider system 210B. The interaction use engine 224 can process the debiased data to identify use cases associated to the debiased data. The interaction use engine 224 can send the use cases associated to the debiased data or a control command associated to one or more the use cases to the content provider system 210A and the asset provider system 210B.

As used in this specification, eventification refers to the process of extracting the event-level 3PC affirmative action data from the event-level reports 228 and the aggregated summary reports 230. Eventification has multiple advantages. One advantage of eventification is that even though utilizing a different measurement technology altogether, the eventified log is similar in structure to the event-level data recorded by third party cookies. The structure similarity facilitates the insertion of the eventified log into existing data pipelines and other modeling infrastructure built for 3PC data with little changes. The compatibility of the eventified log with existing data pipelines reduces technical debt, facilitating the transition to systems including the ARA configuration engine 202. Another advantage of eventification is that the same eventified log can be used for many use-cases, including top ranked (one or two) dominant use-cases of reporting and bidding. For reporting, the eventified log can be aggregated as appropriate to the slice for which reporting is used, for example at the campaign level. For bidding, eventification facilitates training of machine learning models using affirmative action counts and associated values (e.g., conversions and associated conversion values) as labels and with interaction-event characteristics as features. The training of machine learning models use as input a training dataset with units of interaction-events and attributed conversion (or conversion values) combinations, matching the structure of the eventified logs. Building both the reporting and the bidding off the same log can reduce processing complexity and automatically provides consistency across use-cases.

### The Role of Configuration

FIG. 3A depicts a flowchart of an example process 300, according to some implementations of the present disclosure. The example process 300 can be executed using, e.g., any component of the example system 100 described with reference to FIG. 1 or example system 200 described with reference to FIG. 2. Operations of the process 300 are described below for illustration purposes only. Operations of the process 300 can be performed by any appropriate device or system, e.g., any appropriate data processing apparatus. Operations of the process 300 can also be implemented as instructions stored on a computer readable medium which can be non-transitory. Execution of the instructions causes one or more data processing apparatus to perform operations of the process 300.

At 302, aggregate summary reports are configured, according to data privacy settings defined by an ARA configuration engine (e.g., ARA configuration engine 132, or ARA configuration engine 202 described with reference to FIGS. 1 and 2). The ARA configuration engine can include one or more configurable elements including interaction data collection and processing settings that can be under the control of a system administrator (e.g., service-tech). The customizable elements can be set for particular types of interaction data traffic, such as configuration on a per-service provider basis. The aggregated summary reports include aggregates of interaction data, collected according to data collection settings defined by an ARA configuration engine. The data aggregates include grouping of event-attributed affirmative action data that is aggregated to a slice level (e.g., a group of data aggregates) defined by an ARA configuration engine. The aggregated summary reports can be configured based on a pre-definition of the slices, over which an interaction provider system plans to learn about affirmative action counts and associated values (e.g., conversion activity). For example, the aggregated summary reports can be configured to provide information focused on answering a particular question. A question used for interaction data analysis can be: “How many conversions were there in a particular country?” or “What was the sum total of purchase values yesterday?” The type of information used for aggregation can be useful for reporting use-cases, by which service provider systems can gain insights about the offered interaction-campaign, as opposed to a click-by-click (or view-by-view) basis. Even though, the aggregated summary reports are structured to provide aggregated data associated to a particular topic, the underlying raw aggregated summary report can provide additional information beyond the initial aggregation scope. To extract additional information, the aggregated summary reports can be formatted relative to the applied structure configuration. The configuration of the aggregated summary reports includes an adjustment of the limits off the aggregated summary reports. The limits in the aggregated summary reports can be configured, using the ARA configuration engine, by distributing the per-interaction sensitivity parameter across multiple affirmative action counts and associated values. The limits in the aggregated summary reports can potentially be implemented by the APIs to protect privacy of user data related to interaction events (e.g., interactions with user interfaces displaying interaction). The aggregated summary reports offer a type of flexibility that can be used to capture the attribution configuration.

At 304, event level reports are configured, according to data privacy settings defined by an ARA configuration engine (e.g., ARA configuration engine 132, or ARA configuration engine 202 described with reference to FIGS. 1 and 2). The event-level reports include event corresponding to interaction-events generated according to multiple outcome configuration types defined by the ARA configuration engine. The granularity of an event-level report is defined by an interaction, such as a click or a view. The API uses the ARA configuration to generate processed interaction data in parallel to information about any affirmative actions that can (or cannot) have happened within a predefined duration after a respective interaction. Data extracted from the event-level reports can be paired with metadata indicative of the respective affirmative action(s). To protect user privacy, the API (according to the ARA configuration) does not return the event-level data with full fidelity (without deviations). The API (according to the ARA configuration) can select a small proportion of service-interactions to be assigned random affirmative action (configuration) metadata. In some implementations, the ARA configuration can set limits on how much metadata can be extracted from the affirmative actions (e.g., conversions).

At 306, false positives are determined and removed from the configured aggregate summary reports and event level reports. False positives can be determined by leveraging the hierarchical nature of the aggregated summary reports. The hierarchy of the aggregated summary reports facilitates efficient and flexible processing of the aggregated summary reports for identification of use cases. The “hierarchical” structure includes end arrangement of aggregates in a tree-like structure, where parent “leaves” are split into children “leaves” with each additional key. The hierarchy of the aggregated summary reports includes aggregate slices corresponding to parent event nodes and children event nodes, wherein unrelated branches including one or more nodes can correspond to false positive events. The false positive events are aggregate slices that are determined to have been artificially added to the aggregated summary reports without being related to any affirmative actions (e.g., conversions) of actual human interactions. The results in aggregate slices that falsely appear to include affirmative actions (e.g., conversions) define false positives that are identifiable based on the structure of the aggregated summary reports. The structure schema (aggregation keys) used for aggregations can be stored in a database (e.g., the digital component repository 212, described with reference to FIG. 2). For example, the ARA used to generate the aggregation structure can be pre-registered by the content provider system (e.g., the content provider system 106, 210A, described with reference to FIGS. 1 and 2) before the aggregated summary reports are received. In some implementations, the content provider systems can register multiple aggregate keys that can be used for affirmative actions (e.g., conversions). False positive identification can include processing the aggregated summary report using each of the aggregation keys being stored. In response to identifying false positives representing error-filled aggregates in the configured aggregated summary reports, the false positives are removed from the data. A variety of techniques can be implemented to filter out false positives. In some implementations, the event-level reports can used to reduce false positives. For example, if click-through conversion setting is considered, each click can register a triplet of affirmative actions (e.g., conversions), each corresponding to a triplet of bits of metadata, over three-time windows. If a click is indicated in the aggregated summary reports that resulted in an affirmative action (e.g., conversion) but was reported by the event-level reports as having no affirmative actions (e.g., conversions), the respective click can be a false positive on a noised branch. Identifying an entry of the configured aggregated summary reports as being on a noised branch, the entry can be randomly attributed to the single bucket with no affirmative actions (e.g., conversions). If the probability of the entry to be a false positive exceeds a set threshold (e.g., the chance of the entry to be corresponding to some true affirmative actions (e.g., conversions), is below an acceptable threshold), the aggregate slices including false positives are reduced, helping to improve data quality. In some implementations, event level reports are debiased, using a debiasing engine, to generate debiased event API data. Debiasing can include a post mapping process, based on (trainable) machine learning models, which maps conversion metadata values to conversion types or biddability information included in the event level reports, to generate debiased event API data. The debiased event data has the same structure type as the original interaction data, lacking private user information or having private user information replaced with generic user information. The debiased event data can be processed to generate interaction use case data without breaching privacy and security measures imposed by system privacy settings.

At 308, statistics are generated by merging the debiased event level reports and denoised aggregation summary reports. In response to determining that the noise was reduced from the aggregates by post-processing the aggregated summary report data, the denoised aggregates can be used to post-process the event-level report data and create a unified, more accurate eventified log for various use-cases, the accuracy being increased by the described denoising and debiasing procedures. The eventification can include bidding based on training of machine learning models using affirmative actions (conversions or conversion values) as labels and with interaction-event characteristics as features. The training of machine learning models uses as input a training dataset with units of interaction-events and attributed affirmative actions (conversion or conversion values) combinations, matching the structure of the eventified logs. Building both the reporting and the bidding off the same log can reduce processing complexity and automatically provides consistency across use-cases. For example, a training system can be used to train a machine learning model on the denoised aggregates and the event-level report data to predict values for the eventified log, resulting in a trained model. The affirmative actions (conversions or conversion values) can be provided to the training system as input features, and the interaction-event characteristics contain values can be provided to the training system as target outputs. The training system can pick the type of machine learning model to be trained, e.g., pick a predefined or default type of machine learning model, or analyze the input features and the target outputs to identify a type of machine learning model according to reports according to event scenarios. For example, types of machine learning models can include a gradient boosted trees model, a generalized linear model, a support vector machine, a decision tree model, or a neural network model, e.g., a multilayer perceptron (MLP). The machine learning models can be trained using machine learning training algorithms such as minimizing an error, computing a gradient, or performing backpropagation. In some implementations, the training system can use the metadata corresponding to denoised aggregates and the event-level report data to preprocess the values of the interaction-event characteristics to provide to the training system. For example, by using metadata that identifies the type of data for the values, the system can preprocess the values so that the training system can more accurately interpret the values. In other words, the training system can map the affirmative action values in the cell into encoded representations that can be provided as input features for the training of the machine learning model. For example, the system can convert each pair of denoised aggregates and the event-level report data to predict values for the eventified log in a format that the content provider system and/or the asset provider system can interpret, such as for use cases. The event-level data provided by the event-level report data can be processed for event denoising including identification of noising and truncation of affirmative actions on these events. Each event in the event-level report data is transformed using the affirmative actions reported by the event-level reports for that event by implementing a denoising transformation. The denoising transformation corrects both for the randomized response noising implemented by the event-level reports and the truncation it imposes on attributed affirmative actions. The transformation is data-driven and takes as input a set of summary statistics that index key aspects of the underlying data generating process. The summary statistics are determined from the improved aggregates to obtain from the aggregated summary reports after post-processing.

At 310, interaction use cases are determined. An integrated event-level log that reports affirmative actions attributed to each event that have been corrected for the noise and truncation of the event-level reports is generated. The correction leverages information from the aggregated summary reports by merging information from both API taking advantage of the information content of both event-level reports and aggregated summary reports. The integrated event-level log when aggregated can be consistent with the post-processed aggregates from the aggregated summary reports. Interaction use cases are determined for the integrated event-level log. For example, digital components associated to integrated event-level log derived from the raw aggregated summary reports merged with the debiased event data can be identified using data content mapping and obtained from a data base. The mapped digital components can be electronically stored in a physical memory device as a single file or in a collection of files, such as video files, audio files, multimedia files, image files, or text files and include interaction information, such that an interaction is a type of digital component. For example, the digital component can be content that is intended to supplement content of a web page or other resource presented by an application executed by a client device. More specifically, the digital component can include digital content that is relevant to the resource content (e.g., the digital component can relate to the same topic as the web page content, or to a related topic). The provision of digital components can supplement, and generally enhance, the web page or application content providing access to an asset providing system.

At 312, operations of service providing systems are activated using interaction use cases. A trigger to activate the operations of asset providing systems using interaction use cases is generated. The trigger can automatically activate execution of one or more operations corresponding to the determined interaction use cases. The operations can include establishment of a communication channel with the client devices, transmission of the digital components from the database to the client devices, and/or transmission offers corresponding to the digital component from asset providing systems to the client devices. The operations can include an automatic modification of a display of the client devices to increase a visibility of the automatically triggered display of the digital component.

The example process 300 provides a schematic of how ARA configuration leverages protection of the user data privacy. The ARA configuration can be set to generate the event-level and the aggregate summary reports API to obtain data usable for statistical analysis. The example process 300 provides a blended dataset that is leveraged for use cases defined by service questions. Leveraging both report types provides the advantage of maximizing the utility potential of the data in answering the service questions while preserving data privacy and the system security. The example process 300 advantageously integrates ARA configuration and/or customization, facilitating flexible interaction data usage. The flexible nature of the ARA configuration supports a wide variety of measurement use-cases across a rich diversity of service-techs and service providers. The ARA configuration flexibility can be used to adjust interaction data quality relative to the service. The quality considerations in the aggregate summary reports rely more heavily on ARA configuration than they do on disclosure-processing. In the example process 300, the event debiasing procedure contributes mostly to improving the data quality of event-level reports. Configuration of event-level reports (such as optimal usage of the metadata bits) can be service technology specific, having a unique ARA configuration. Further details of portions of the example process 300 are described with reference to FIG. 3B.

FIG. 3B depicts a flowchart of another example process 320, according to some implementations of the present disclosure. The example process 320 can be executed using, e.g., any component of the example system 100 described with reference to FIG. 1 or example system 200 described with reference to FIG. 2. Operations of the example process 320 are described below for illustration purposes only. Operations of the process 320 can be performed by any appropriate device or system, e.g., any appropriate data processing apparatus. Operations of the example process 320 can also be implemented as instructions stored on a computer readable medium which can be non-transitory. Execution of the instructions causes one or more data processing apparatus to perform operations of the example process 320. The example process 320 can be included in the example process 300 with reference to FIG. 3A or can be executed in response to a portion of the example process 300, such as aggregate summary report configuration setting.

At 322, a sensitivity level for interaction data collection is received from a memory (e.g., memory 114A described with reference to FIG. 1) storing the ARA configuration. The sensitivity level can be defined, using ARA configuration, at an interaction level of the interaction data. The sensitivity level corresponds to a sensitivity budget allocation representing a first-order consideration for ARA configuration. The sensitivity level defines interaction level parameters monitored for collection of the interaction data. For example, the sensitivity level can define a duration, or a number of interactions associated with a service and/or an event for collecting the interaction data.

At 324, a maximum number of conversions for collecting interaction data can be set, using ARA configuration. The conversions can include any type of interaction data anonymization functions, such as data encryption, data aggregation, information truncation, and addition of noise. The maximum number of conversions defines a conversion threshold applied to the conversions. As a context example, a maximum allowable number of conversions per service (e.g., testing) or per set of interactions can be set, by the ARA configuration, to generate the aggregate summary reports. The maximum number of conversions can affect the data quality, by increasing or decreasing the noise added to the interaction data and can be selected within a range, in which user data privacy is preserved while converted data still includes valuable data that can be used for statistical analysis, the utility gain being derived from the aggregate side coming from conversion configuration adjustments.

At 326, the collected interaction data are converted (e.g., by filtering, truncation, aggregation, and/or any other type of data anonymization technique) using the maximum number of conversions to generate converted data. The converted data can be used for training models (e.g., training engine 222 described with reference to FIG. 2) of conversions that define the conversion number range, in which user data privacy is preserved while converted data still includes valuable data for the particular interaction data type that was collected.

At 328, contributions are assigned to converted data to generate scaled data. A scaling factor is added to the converted data to generate scaled data within particular units. The effective amount of noise is determined by the scaling factor: the larger the scaling factor, the smaller the effective amount of noise. The effective amount of noise in aggregate summary reports can be controlled to some extent by adjusting the ARA configuration, by simply modifying the scaling factor, which can be controlled by the service-tech. For example, if the scaling factor is increased to 1000, the resulting standard deviation would correspond to ten times decrease in noise. The ARA configuration includes a guardrail to prevent the noise to be decreased to zero. The guardrail can be a built-in constraint on the size of the scaling factor of the ARA configuration.

At 330, scaled data are aggregated by splitting the scaled data across a plurality of levels of an aggregate hierarchy according to a sensitivity budget set in the ARA configuration. The sensitivity budget given to each interaction defines a constraint of the total sum of all scaled contributions for any interaction. The noise added is proportional to the sensitivity budget. The sensitivity budget is defined at an interaction level, and not at a conversion level.

At 332, noise is added to aggregated scaled data to generate noisy aggregated data. The noise is determined by the scaling factor and the sensitivity budget. The noise includes Laplace noise added to each of the data slices. The noise can be applied using a noising transformation that uses a set of summary statistics that index aspects of the conversion type.

At 334, the noisy aggregated data is rescaled to generate rescaled data as aggregate summary reports. The aggregate summary reports are within a unit range set by rescaling parameters. The aggregate summary reports include hierarchically structured event-attributed conversion data as nodes distributed in a plurality of levels. The aggregate summary reports are associated to metadata corresponding to a conversion type applied to the structured event-attributed conversion data.

At 336, the rescaled data is transmitted to a service provider system configured to determine use cases of the rescaled data that can be associated to one or more services. Interaction use cases are determined from the rescaled data based on a relevance of the rescaled data to one or more target services.

The example process 320 provides the advantage of protecting user data privacy and applicability of determined use cases. The data privacy is protected by the example process 320 through noise inclusion. If the example process 320 would include no noise (e.g., if the noise, L, were to equal 0) in the aggregated scaled data, the original conversion count can be determined. The example process 320 applies the same type of noise to the scaled space, which enables replacement of noise with generic data. While the added noise is a random quantity (and therefore cannot be predicted perfectly), it is the same type of random quantity in terms of its distribution (e.g., from a Laplace distribution with fixed parameters), enabling efficient noise removal to maximize the quality of the use data.

FIG. 4A depicts a schematic diagram illustrating an example three-click model 400, in accordance with some example implementations. The example three-click model 400 illustrate conversions that followed each interaction (click) 402A, 402B, 402C in a series of clicks. The interaction data of the first interaction (click) 402A can be converted using a first set of multiple (e.g., 5) conversions 404A, 406A, 408A, 410A, 412A. The interaction data of the second interaction (click) 402B can be converted using a second set of multiple (e.g., 7) conversions 404B, 406B, 408B, 410B, 412B, 414B, 416B. The interaction data of the third interaction (click) 402C can be converted using a third set of multiple (e.g., 2) conversions 404C, 406C.

FIG. 4B depicts a schematic diagram 420 illustrating an example click-conversion scenarios, in accordance with some example implementations. The schematic diagram 420 indicates an effect of a many-per-click (MPC) setting selected in the ARA configuration. The ARA configuration introduces noise and truncation to the underlying conversion data in order to protect user privacy. The schematic diagram 420 depicts two identical click-conversion scenarios under two different MPC settings 422, 424. Under the first setting 422, the MPC is set to 5 and two conversions are dropped for the second click because the sensitivity budget has been exhausted, leading to truncation. According to the second setting 424, the MPC is set to 7. For the second setting 424, all conversions are captured, at the cost of more noise since each conversion is forced to use less of the sensitivity budget. The schematic diagram 420 indicates that registering multiple conversions is at odds with the goal of maximizing contributions: the more conversions are intended to be registered, the less per-conversion budget would have to be set in the ARA configuration, for contributions. In other words, the MPC choice involves an explicit tradeoff between truncation (e.g., conversion coverage) and noise (e.g., accuracy). A reduction of any of the truncation and noise triggers an increase of the other. For example, changing the MPC limit from 1 to 10 allows for more conversions to be registered, which proportionally increase the noise (since contributions per conversion must be reduced).

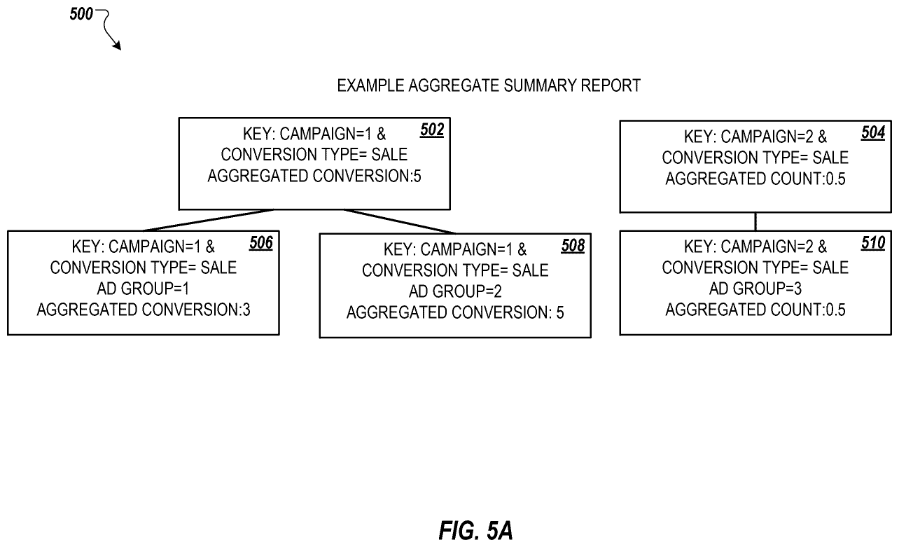

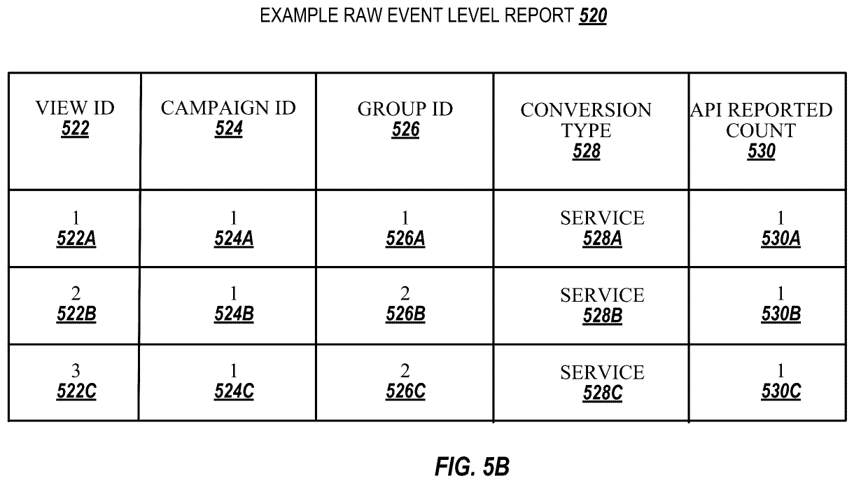

FIG. 5A depicts a schematic diagram illustrating an example aggregate summary report 500, in accordance with some example implementations. As shown in FIG. 5A, the aggregated summary reports are hierarchically structured, including one or more parent nodes 502, 504 and one or more child nodes 506, 508, 510. Each parent node 502 or 504 can have one or more child nodes 506, 508, or 510, respectively. Each node of a particular type can include a set of data types. For example, the parent nodes 502, 504 can include keys, conversion (configuration) types, and aggregated conversion (configuration) counts. Each child node of a particular type can include a set of data types. For example, the child nodes 506, 508, 510 can include the set of data types of the respective parent node and one or more additional data. In the illustrated examples, the child nodes 506, 508, 510 include keys, conversion types, ad groups, and aggregated conversion counts.

In the illustrated example, the aggregated summary report 500 is aggregated as “keys” (e.g., Campaign ID, Ad Group, Conversion Type), a specific instantiation of those keys as “key-values” (Campaign ID==1, Ad Group==1, Conversion Type==“Sale”) and the aggregate data corresponding a particular key-value as an “aggregate.” The data reported in each box in the aggregated summary report 500A is an “aggregate” representing a specific combination of the event and conversion characteristics. The aggregated summary report 500A provides datasets whose elemental granularity is at the level of aggregates. The aggregates reported by the Aggregate-API are not perfectly accurate because the aggregated summary report 500A, includes statistical noise that is added to the counts for differential privacy reasons. Granular nodes and leaves of an aggregated summary report 500 tend to be more impacted than coarse aggregate nodes near the top of the tree. In the presence of noise and truncation it cannot be possible to achieve highly accurate aggregates at highly granular slices for all service providers. The tradeoff between protecting data privacy and accuracy of retrieved data for use cases can be considered when setting the ARA configuration.

The data in the aggregated summary report 500 has been aggregated in a specific way: first, by Campaign, then by Conversion type first; and then by interaction-group. The specifics of the aggregates and how the aggregates can be organized is under the control of the content provider system. The content provider system can choose to aggregate the data in a way that can be mapped to a particular operation of an interaction use case. The aggregated summary reports can report a result even in cases where there were no factual conversions due to the noising mechanism introduced to protect user data privacy. In the illustrated example, the two boxes on the right report some conversions for Campaign 2, wherein in reality there were none.

The aggregated summary report 500 can be configured to be within set limits of how many contributions can be registered against a given interaction for representation in the aggregated summary reports. The event-level conversions following an interaction-event can be truncated by the set limits, and aggregates can be based on the truncated conversions. The limits can manifest in undersized aggregates if the conversion activity exceeds them. The limits in the aggregated summary reports can be configured by the content provider system by distributing the per-interaction LI sensitivity parameter across potentially several conversions. The aggregated summary reports can offer a type of flexibility which can be used to capture the attribution description better.

The sensitivity budget allocation set in the ARA configuration can be useful for another key situation in the ARA where contribution “splitting” arises. The described issue relates to the hierarchical structure. For example, in a hierarchical structure, each conversion can contribute to each level of the hierarchy and contributions are split across each of the hierarchy levels. The targeted aggregate structure can have N levels, where each level is created by appending some additional dimensions to its parent level. A simple example of two levels can include: Level 1: Campaign, Conversion Type and Level 2: Campaign, Conversion Type, and Group.

In the example of FIG. 5A, the key dimension “Ad Group” makes Level 2 more granular than Level 1. The hierarchical structure can be a useful construct but can also be replaced by other structure types. For example, the ARA does not differentiate between hierarchical and non-hierarchical structures when it aggregates interaction data. The ARA can count contributions for particular aggregate buckets.

That is, the ARA views the above hierarchy in the following way when constructing Aggregate Summary Reports:
Bucket 1: Campaign==1, Conversion Type==Sale
Bucket 2: Campaign==2, Conversion Type==Sale
Bucket 3: Campaign==1, Conversion Type==Sale, Ad Group==1
Bucket 4: Campaign==1, Conversion Type==Sale, Ad Group==2
Bucket 5: Campaign==2, Conversion Type==Sale, Ad Group==3

When a conversion happens, the allocated contributions can be placed in the bucket(s) with matching attributes, later to be aggregated with other contributions and noised as described above. Note, however, that it is possible (and expected, under a hierarchical setup) for conversions to match multiple buckets. For example, if a conversion on Campaign 1, of Conversion Type Sale, and on Ad Group 1 occurs, it matches both Buckets 1 and 3. If the conversions are selected to contribute to all matching buckets, the conversion's contributions can be split across the respective buckets. For example, a conversion's contribution can be split across all levels of the aggregate hierarchy.

FIG. 5B depicts a schematic diagram illustrating an example event level report 520, in accordance with some example implementations.

The example event level report 520 includes interaction data that can be classified based on multiple categories: view identifier 522, campaign identifier 524, group identifier 526, conversion type 528, API reported count 530 and other potential data types. Data coming from the event-level reports is “event-level” in the sense that a record for each interaction is received and paired with metadata corresponding to the subsequent conversion(s). The example event level API input data 520 can include interaction data that forms the input into the API. The example event level API input data 520 includes 3 interaction-events depicted (view IDs: 1-3 522A-522C). The interaction-events are corresponding to several interaction-event features such as which campaign and interaction-group they correspond to.

Conversions can have associated metadata, such as conversion type 528A-528C (e.g., sale or purchase) and conversion value describing the service. If conversions occur, the converted data are attributed to the corresponding interaction-view. Each of the views and conversions can be associated to metadata, in that all information is known about each piece. For example, the second view came from a particular campaign 524A-524C (e.g., Campaign 1, interaction-group 2, and resulted in 2 conversions), each of which were sale (purchase) events and totaling for $10 in value. The event-level reports are generated by APIs that use as input the described information, but only report a transformed version of the data back to the content provider system.

FIG. 6 illustrates a block diagram of an example tree 600, in accordance with some example implementations. The example tree 600 shown in FIG. 6 includes an example aggregated data integrating interaction of the data generated in response to an event (e.g., testing or interaction triggering event) related to a product of one or more types, recorded by multiple devices, in one or more regions (e.g., countries) provided for statistical analysis to a service or asset provider (identified by a partner ID). Each node on the example tree 600 represents a particular aggregate slice. Darker nodes correspond to the nodes, which are less susceptible to the addition of noise in aggregate summary reports. The aggregate data under truncation and noise implies a granularity versus accuracy tradeoff. Granular slices are typically more valuable than coarse ones as they provide more detailed conversion measurement (e.g., higher utility), but they are less likely to be measured with high accuracy due to the noising induced by the API (e.g., lower accuracy). Obtaining valuable accurate data is based on a process that provides a balance between the data accuracy and data privacy. The balance can be facilitated by effectively utilizing the configuration levers which are provided by the ARA. Each service provider has different data characteristics and what works best can vary from one service provider to another. The customization of ARA configuration plays an important role in adjusting the balance levels relative to particular use cases relevant for different service providers.

Within a context example, two service providers, A and B are considered, with service provider A having many thousands of conversions and service provider B having very few conversions. A first ARA configuration can provide “thin” slices (with low conversion counts) that have a lower signal to noise ratio and thus be more susceptible to noise. A second ARA configuration can provide “thick” slices (those with high conversion counts) that have a higher signal to noise ratio and thus be less susceptible to noise, relatively speaking. In the described case, service provider A can be able to collect granular data with reasonable accuracy because they have many conversions. On the other hand, the same granular slices for service provider B can be compromised by noise since the slices would be much thinner. The context example indicates a need for intelligent customization of at least a few configurable settings. For instance, service provider B can benefit from collecting more coarse aggregates so that the data is more accurate, at the cost of granularity.

It is common for service providers to have interest in multiple conversion actions following a user interaction. For instance, if an interaction (e.g., click), generated in response to a particular displayed data, leads to multiple target events (e.g., call of another service) over a given time period, the service providers and the system administrator (on behalf of the service providers) can be interested in capturing all of the conversions, rather than just one of them. The collected user interaction information can be used to report on conversions that followed the interaction or to train models of conversions following interactions entered in response to displayed data that are useful for bidding and budgeting automation, using the MPC setting. Because the sensitivity budget is defined at the interaction level, and not at conversion level, all conversions following a single interaction must share the set budget. In addition, since per-conversion contributions are due at the time of conversion registration, the ARA configuration is set prior to the conversion occurring (e.g., at the time of service-interaction). Setting the ARA configuration can include setting a maximum number of conversions intended to be registered for a particular interaction.

The allocation of contributions across hierarchy levels can be non-uniform. The allocation of conversions' contributions across multiple levels affects noise levels, wherein aggregate levels near the top of the tree are coarser than nodes and leaves further down the hierarchy. More conversions and therefore can tolerate higher noise levels, and allocations with increased contributions on lower levels can be selected. One way to reason about this is by envisaging the concept of a useful tree for a service-tech; e.g., a tree of aggregates for which the signal to noise ratio of its nodes is within acceptable/useful limits. By allocating more sensitivity budgets to some nodes of the original aggregate tree, the nodes become less noisy, and in turn, the shape of the tree can be changed. The sensitivity budget can be seen as a tool in the hands of the service-tech to determine the width and depth of its useful aggregate tree. The allocation is not infinitely free, because there is a limit on the total sensitivity budget that can be allocated. Changing the shape of the useful tree by allocating budget on some nodes takes away the budget from others, leading to hard tradeoffs on usefulness across slices that need to be resolved. To summarize the discussion of contribution allocation and MPC limits, the conversion contributions for a particular aggregate level are equal to L₁/MPC limit times fraction allocated for level, where MPC Limit and fraction allocated for level are configurable settings. Under this framing, the MPC limit and sensitivity allocation are intimately connected.

Another ARA configuration defines settings of level granularity, such as on a per-service provider basis. The level granularity defines the characteristics of conversion data that can differ dramatically for similar quantities. For example, the optimal MPC limits can for different fields of service providers, each of which can have a different profile of the number of conversions that follow a displayed data exposure, each having different optimal MPC choices.

The optimization of the ARA customization can be based on an approach including two steps: 1) a definition of an objective function which allows quantification of the tradeoffs (e.g., a mathematical characterization of quality selected to be maximized) and 2) selecting the particular configuration values which optimize the described function.

The optimization approach is converting the open questions posed above into precise optimization problems. With the described framing, the configurations which are most likely to yield high quality aggregate summary reports can be systematically discovered.

A step in any optimization problem is to first define a quantity of interest—what can be optimized? For example, a service provider can select to optimize a conversion volume, or an entity associated with a commuting service can try to optimize for distance traveled or commute time, and so on. The quantities of interest are objective functions and an objective function for aggregate summary reports can be defined based on quantitative assessments of configurations that can be best determined.

In the case of aggregate summary reports, the objective function can be related to accuracy—that is, the data in the reports is expect it to be as close as possible to the underlying ground truth. To that end, some basic definitions can be used:
x: the ground truth conversion count for a particular aggregate slice;
Y: the observed conversion count from aggregate summary reports for that same slice.

With the described definitions, the difference between X and Y can be minimized.

Several options of quantifying the described difference can be explored. A function called Root Mean Square Relative Error (RMSRE). That can be defined as,

$$R M S R E = \sqrt{E [ {( \frac{Y - x}{x} )}^{2} ]} ,$$

where E stands for expected value and is taken over the randomness in Y. The described metric can be derived starting from within the parentheses: (Y−x)/x being the difference between ground truth and reported conversions, relative to the ground truth (e.g., the true number of conversions in the respective slice), considering that aggregate slices can vary dramatically in size. For example, a difference of 5 conversions is acceptable if the ground truth is 1,000 but can be significant if the ground truth is 2. Squaring the relative error allows for a bias/variance decomposition. The expectation is needed since the API applies random noise to the data, such that the relative error is not deterministic, but the expectation is there to compute a “typical” value of the squared relative error.

The square root is there to counteract the square so that the described metric can (loosely) be interpreted as the expected relative error between ground truth and observed value.

One known limitation of relative errors is the susceptibility to explode (e.g., significantly increase) when x is near 0 (in the described case, when aggregate slices with very low conversion counts are examined). A small modification can be made to prevent the described explosion by including protection in the denominator:

$$R M S R {E}_{T} = \sqrt{E [ {( \frac{Y - x}{max ( T , x )} )}^{2} ]} ,$$

The term T is chosen to be some small number (e.g., T=5), and it could vary by service-tech and context. Finally, while the described objective function can be applied to a single aggregate slice, the aggregate tree can be defined based on the averages (or weighted averages) of RMSRE across all slices.

In some implementations, RMSRE as defined above, depends on the configurations that control what is observed in Y—both in terms of noise (more specifically, the effective variance of the noise added to aggregates) and truncation such that configurations, which minimize the described function can be selected.

An objective is to ensure that the correct number of conversions per interaction is registered. For example, if RMSRE is used as the guiding objective, where T since RMSRE depends on the selected MPC limit m, RMSRE (m) can be defined and T can be minimized with respect to m, for a fixed size allocation.

One of the properties of the described function is that it has a particular bias/variance decomposition, which is what is balanced with MPC optimization. First x(m) can be defined to be the MPC-truncated conversion count for the slice for a given choice of m, leading to:

$$E [ {( \frac{Y - x}{max ( T , x )} )}^{2} ] = \frac{1}{{max}^{2} ( T , x )} E [ {( Y - x )}^{2} ] = \frac{1}{{max}^{2} ( T , x )} [ {( x ( m ) - x )}^{2} + Var ( Y ) ] .$$

The objective function can be broken into two components: 1) the impact of truncation: (x(m)−x)² and 2) the impact of noise: Var(Y), since the variance of the noise depends on m.

The term, RMSRE_{T} tries to limit the impact of truncation, while simultaneously avoiding a variance increase by making conversion contributions too small. Note also that since the noise distribution is known, Var(Y) can be expressed analytically (using a formula based on the Laplace distribution).

The following consider the three-click example from FIG. 4A to illustrate how the described optimization works. Suppose that the conversions belonging to the respective clicks (for example, if they correspond to the same aggregation slice) are to be aggregated. In the described case, x=14 but m=5, sch that x(m)=12. That is, there are 14 conversions total, but if only up to 5 conversions per click are allowed, 12 conversions after aggregating are observed. Increasing m to 7 can ensure that there is no truncation, but it increases the noise.

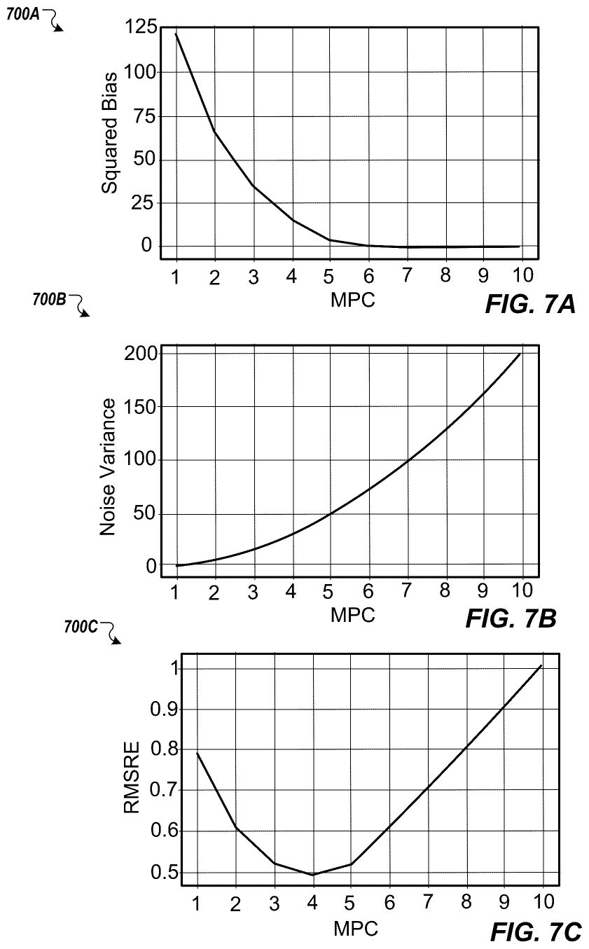

FIGS. 7A-7C depict example plots 700A, 700B, 700C, in accordance with some example implementations. The example plots 700A, 700B, 700C illustrate the relationship between squared bias or noise variance or RMSRE and MPC for aggregate slice (using ϵ=1 as an example).

In the example plots 700A, 700B, 700C, the bias component goes to 0 as long as m is set to 7 or larger, as for these choices of MPC limit, where truncation can be avoided. However, the variance component grows with m. For example, when m=7, the noise variance is 98 (corresponding to a standard deviation of 9.9 conversions) which is large relative to the slice's total conversion count of 14. Finally, RMSRE_{T} finds a graceful balance between these two components, and recommends an MPC limit of 4, which is essentially trying to minimize the noise level by allowing for some truncation, such that the MPC problem is a particular example of the classical bias variance tradeoff from statistics. The described example is using ϵ=1, and one would find different tradeoffs under different values of ϵ.

For a hierarchical setup, conversions can be distributed into multiple aggregation slices, the distribution being allocated according to a selected sensitivity across the slices. A tradeoff is selected between leaf nodes (at bottom) that contain the most information since they are the most granular, and respective granularity (making them more sensitive to noise).

To solve the described problem, one can also use RMSRE_{T} as the objective function, but in the described case, consider the objective as a function of b which is a vector of fractions which correspond to sensitivity budget per level. For example, in the four-level hierarchy depicted above, using b=[0.25, 0.25, 0.25, 0.25] corresponds to splitting the sensitivity budget equally across all four levels of the hierarchy, while b=[0.01, 0.97, 0.01, 0.01] corresponds to putting most of the budget at the second level. In the described way, with respect to RMSRE-(b), the value of b is found, which provides the most accurate tree as a whole (for example, taking the average RMSRE_{T} over all nodes or something similar). The optimal solution can be found by standard constrained optimization algorithms or in small cardinality situations, by brute-force enumeration.

Generally, allocating more budget toward the bottom of the tree is required to ensure that the thinnest slices can be measured accurately. If the disclosure-processing technique is used, information can flow up the tree as well, so that children nodes can improve their parents, facilitating allocation of sensitivity budget towards lower nodes of the tree. The described implementation provides substantial benefits stemming from the usage of the interaction between disclosure-processing techniques and configuration.

In some implementations, there are circumstances where very granular measurement is not possible, such as cases where the tree is very sparse, the optimal MPC is very large, or when e is small. In these cases, a minimum quality bar can be set, where if a slice cannot reach the described bar under any budget allocation, the slice is removed, and the budget is allocated at a less granular level. The described optimization approach assumes knowledge of ground truth conversion counts which is not realistic. However, looking at historical API data can serve as a useful proxy for conversion volumes, even when the historical data is coming from naively configured ARA reports. The effectiveness of optimized configuration can be tested on a public dataset, e.g., provided by CRITEO. The testing results show that particular customized configurations are beneficial in terms of data accuracy.

The dataset is click-level, meaning every row is a click with some click and conversion features for Partner IDs (partner corresponding to the product seller). While an original conversion column can be binary, the dataset can be augmented to include the possibility of multiple conversions per interaction (e.g., click). For example, for each associated service, a zero-truncated Poisson distribution can be sampled with a rate dependent on the Partner ID's overall conversion rate. Interactions that do not trigger an associated service can be omitted, for the sake of simplicity. The table includes a small sample of the event-level data according to the described demonstration.

| | | | | number_of |
|---|---|---|---|---|
| partner_id | product_country | device_type | product_age_group | conversions |
| 46 | 5 | 2 | 5 | 1 |
| 1 | 1 | 2 | 1 | 5 |
| 1 | 1 | 2 | 1 | 7 |
| 1 | 1 | 1 | 1 | 4 |
| 80 | 2 | 3 | 1 | 8 |
| 1 | 1 | 2 | 1 | 8 |
| 1 | 1 | 2 | 1 | 7 |
| 1 | 1 | 2 | 1 | 4 |
| 1 | 1 | 1 | 1 | 3 |
| 1 | 1 | 1 | 1 | 7 |

From the data shown in the first column of the table, a four-level aggregate tree can be obtained for every partner and the difference between data quality under naive vs. optimized configuration can be determined.

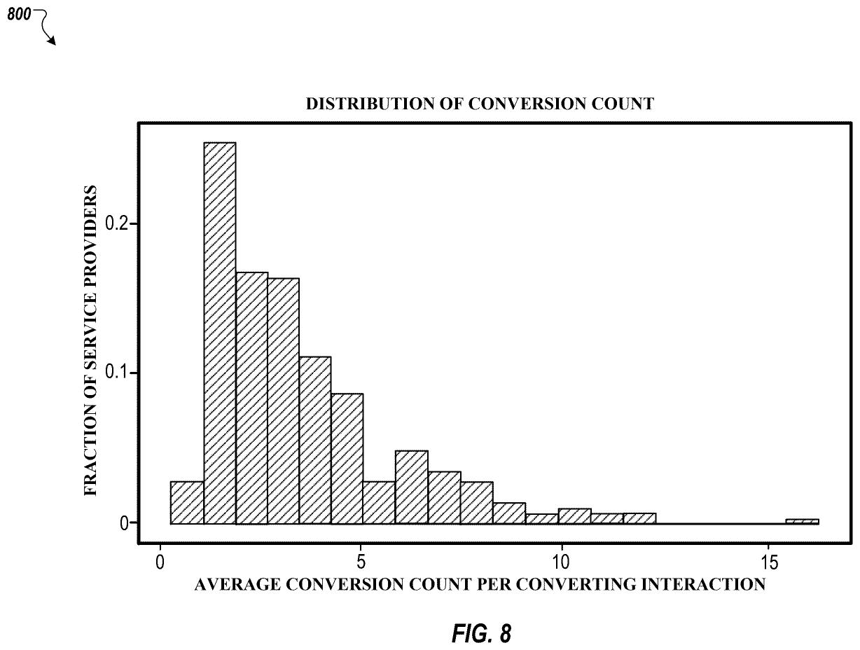

FIG. 8 depicts an example distribution conversion count graph 800, in accordance with some example implementations. The example distribution conversion count graph 800 reflects a baseline configuration including setting of some informed but relatively naive settings for both the MPC limit and sensitivity budget allocation. For MPC, a global MPC limit of 15 can be set for a selected number of service providers, considering that most conversions can be retained with such a limit. For sensitivity budget split, b=[0.25, 0.25, 0.25, 0.25] as the baseline, sensitivity budgets can be equally split across the four aggregation levels.

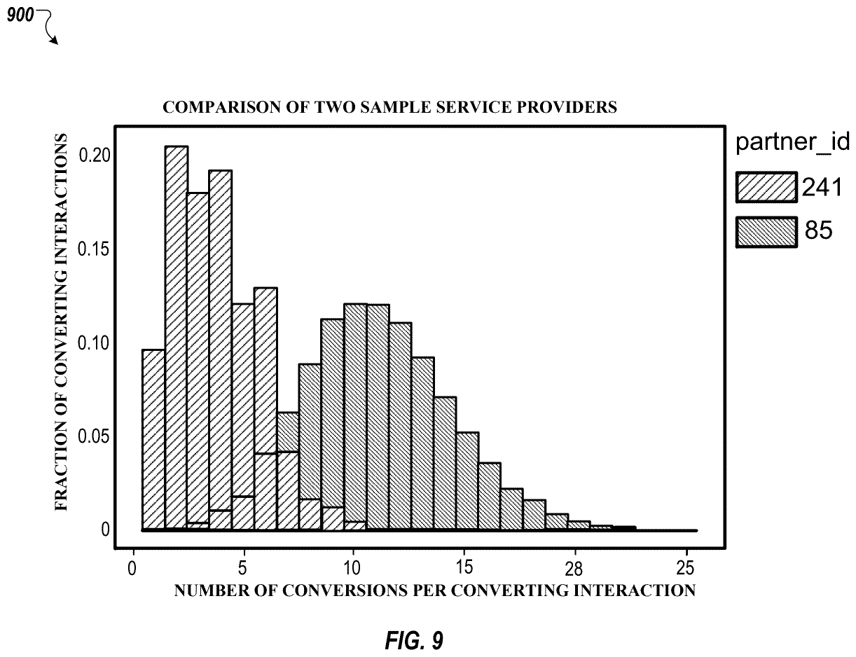

FIG. 9 depicts an example comparison graph 900, in accordance with some example implementations. The example comparison graph 900 illustrates customized configurations. The dataset can be used on a per-partner basis, to find differences between service providers. For example, consider the comparison shown in FIG. 9 in terms of conversions per click: Partners 241 and 85 have significantly different conversion behavior, where the baseline MPC limit of 15 is larger than necessary for Partner 241, while for Partner 85 the same limit would result in non-trivial conversion truncation. The MPC is customized on a per-partner basis by choosing the minimum m such that there is no resulting truncation.

In terms of sensitivity budget, the following allocations are considered:

$$[ 0.25 , 0.25 , 0.25 , 0.25 ]$$

$$[ 0.97 , 0.01 , 0.01 , 0.01 ]$$

$$[ 0.01 , 0.97 , 0.01 , 0.01 ]$$

$$[ 0.01 , 0.01 , 0.97 , 0.01 ]$$

$$[ 0.01 , 0.01 , 0.01 , 0.97 ]$$

Each allocation is used and the one which yields the most aggregate slices of high quality is applied, where a threshold of RMSRE≤0.1 is set. The described optimization is done separately T for each service provider.

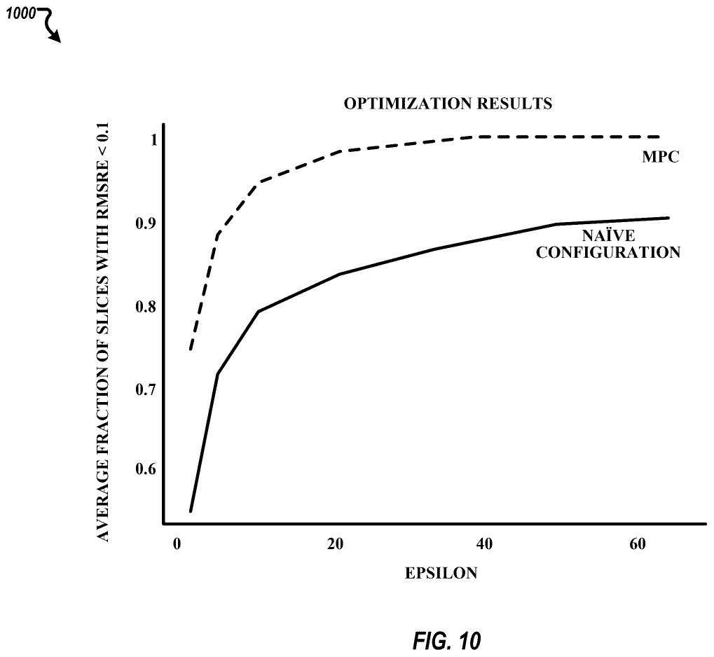

FIG. 10 depicts an example result graph 1000, in accordance with some example implementations. The example result graph 1000 shows test results. As illustrated in FIG. 10, optimizing the configurations leads to large improvements in utility for all values of c. For example, for ϵ=20, the average fraction of high-quality slices jumps from ~84% under the naive config to ~98% for the optimized configuration.

The magnitude of the described difference can depend on several service-tech dependent factors, such as the shape and complexity of the aggregate trees, conversion rates, the presence of false positives, and handling of conversion values. Significant improvements were found in interaction conversion data by leveraging the configurable components of the ARA configuration. The current disclosure shows the power of intelligent configuration of the ARA by focusing on customized MPC limits and sensitivity budgets. While the configurable levers can have a high impact on data accuracy, there are several other configurable settings in both the aggregate summary reports and the event-level reports that can be used to maximize data utility.

The magnitude of the described difference can depend on several service-tech dependent factors, such as the shape and complexity of the aggregate trees, conversion rates, the presence of false positives, and handling of conversion values. Significant improvements were found in interaction conversion data by leveraging the configurable components of the ARA configuration. The current disclosure shows the power of intelligent configuration of the ARA by focusing on customized MPC limits and sensitivity budgets. While these configurable levers can have a high impact on data accuracy, there are several other configurable settings in both the aggregate summary reports and the event-level reports that can be used to maximize data utility.

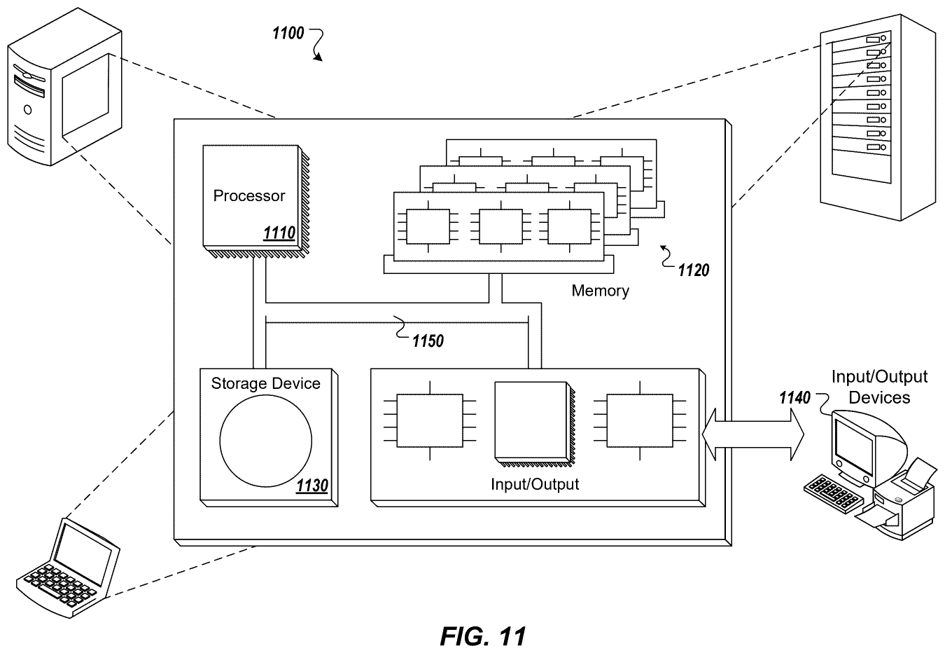

Referring now to FIG. 11, a schematic diagram of an example computing system 1100 is provided. The system 1100 can be used for the operations described in association with the implementations described herein. For example, the system 1100 can be included in any or all of the server components discussed herein, such as the components of the example system 100 described with reference to FIG. 1. The system 1100 includes a processor 1110, a memory 1120, a storage device 1130, and an input/output device 1140. The components 1110, 1120, 1130, 1140 are interconnected using a system bus 1150. The processor 1110 is capable of processing instructions for execution of processes (e.g., example process 300 described with reference to FIG. 3) within the system 1100. In some implementations, the processor 1110 is a single-threaded processor. In some implementations, the processor 1110 is a multi-threaded processor. The processor 1110 is capable of processing instructions stored in the memory 1120 or on the storage device 1130 to display graphical information for a user interface on the input/output device 1140.

The memory 1120 stores information within the system 1100. In some implementations, the memory 1120 is a computer-readable medium. In some implementations, the memory 1120 is a volatile memory unit. In some implementations, the memory 1120 is a non-volatile memory unit. The storage device 1130 is capable of providing mass storage for the system 1100. In some implementations, the storage device 1130 is a computer-readable medium. In some implementations, the storage device 1130 can be a floppy disk device, a hard disk device, an optical disk device, or a tape device. The input/output device 1140 provides input/output operations for the system 1100. In some implementations, the input/output device 1140 includes a keyboard and/or pointing device. In some implementations, the input/output device 1140 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a particular activity or bring about a particular result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a reservice-only memory or a random-access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps can be provided, or steps can be eliminated, from the described flows, and other components can be added to, or removed from, the described systems. A number of implementations of the present disclosure have been described. Nevertheless, it can be understood that various modifications can be made without departing from the spirit and scope of the present disclosure. In view of the above-described implementations of subject matter the application discloses the following list of examples, wherein one feature of an example in isolation or more than one feature of said example taken in combination and, optionally, in combination with one or more features of one or more further examples are further examples also falling within the disclosure of the application.

Example 1. A computer-implemented method comprising: receiving, by one or more processors from a configuration of an attribution reporting application programming interface (ARA), a sensitivity level of an application programming interface for collecting interaction data, the sensitivity level defining parameters of an interaction level monitored for collection of the interaction data; receiving, by the one or more processors from the configuration of the ARA, a maximum number of affirmative actions to be applied to the interaction data collected within the sensitivity level, the maximum number of affirmative actions defining a truncation applied to the affirmative actions; converting, by the one or more processors, the interaction data using the maximum number of affirmative actions to generate an affirmative action count; assigning, by the one or more processors, a scaling contribution to the affirmative action count to generate scaled data within particular units; aggregating, by the one or more processors, the scaled data by splitting the scaled data across a plurality of levels of an aggregate hierarchy of a targeted aggregate structure, to generate aggregated data; adding, by the one or more processors, noise to the aggregated data to generate noisy aggregated data; rescaling, by the one or more processors, the noisy aggregated data, using a scaling factor to generate rescaled data as aggregate summary reports, the aggregate summary reports being within a unit range set by the scaling factor; and transmitting, by the one or more processors, the rescaled data to determine use cases.

Example 2. The computer-implemented method of the preceding example, wherein the sensitivity level and the maximum number of affirmative actions affect a balance between the data accuracy and data privacy.

Example 3. The computer-implemented method of any of the preceding examples, further comprising: receiving, by the one or more processors from the configuration of the ARA, a many-per-click (MPC) limit defining a number of affirmative actions to be registered; and truncating, by the one or more processors, the affirmative actions using the MPC limit.

Example 4. The computer-implemented method of any of the preceding examples, wherein the noise comprises Laplace noise added to each data slice of the aggregated data.

Example 5. The computer-implemented method of any of the preceding examples, wherein the noise is applied using a noising transformation that uses a set of summary statistics that index aspects of the affirmative actions type.

Example 6. The computer-implemented method of any of the preceding examples, wherein an increase of the scaling factor decreases the noise.

Example 7 The computer-implemented method of any of the preceding examples, wherein the increase of the scaling factor is limited by a limit defined by the configuration of the ARA.

Example 8. The computer-implemented method of any of the preceding examples, further comprising: using, by the one or more processors, the affirmative action count for training models of affirmative actions.

Example 9. The computer-implemented method of any of the preceding examples, wherein the aggregate summary reports comprise hierarchically structured event-attributed affirmative action count as nodes distributed in a plurality of levels.

Example 10. A computer-implemented system comprising: memory storing application programming interface (API) information; and a server performing operations comprising: receiving, by one or more processors from a configuration of an attribution reporting application programming interface (ARA), a sensitivity level of an application programming interface for collecting interaction data, the sensitivity level defining parameters of an interaction level monitored for collection of the interaction data; receiving, by the one or more processors from the configuration of the ARA, a maximum number of affirmative actions to be applied to the interaction data collected within the sensitivity level, the maximum number of affirmative actions defining a truncation applied to the affirmative actions; converting, by the one or more processors, the interaction data using the maximum number of affirmative actions to generate an affirmative action count; assigning, by the one or more processors, a scaling contribution to the affirmative action count to generate scaled data within particular units; aggregating, by the one or more processors, the scaled data by splitting the scaled data across a plurality of levels of an aggregate hierarchy of a targeted aggregate structure, to generate aggregated data; adding, by the one or more processors, noise to the aggregated data to generate noisy aggregated data; rescaling, by the one or more processors, the noisy aggregated data, using a scaling factor to generate rescaled data as aggregate summary reports, the aggregate summary reports being within a unit range set by the scaling factor; and transmitting, by the one or more processors, the rescaled data to determine use cases.

Example 11. The computer-implemented system of the preceding example, wherein the sensitivity level and the maximum number of affirmative actions affect a balance between the data accuracy and data privacy.

Example 12. The computer-implemented system of any of the preceding examples, wherein the operations further comprise: receiving, by the one or more processors from the configuration of the ARA, a many-per-click (MPC) limit defining a number of affirmative actions to be registered; and truncating, by the one or more processors, the affirmative actions using the MPC limit.

Example 13. The computer-implemented system of any of the preceding examples, wherein the noise comprises Laplace noise added to each data slice of the aggregated data.

Example 14. The computer-implemented system of any of the preceding examples, wherein the noise is applied using a noising transformation that uses a set of summary statistics that index aspects of the affirmative actions type.

Example 15. The computer-implemented system of any of the preceding examples, wherein an increase of the scaling factor decreases the noise.

Example 16 The computer-implemented system of any of the preceding examples, wherein the increase of the scaling factor is limited by a limit defined by the configuration of the ARA.

Example 17. The computer-implemented system of any of the preceding examples, wherein the operations further comprise: using, by the one or more processors, the affirmative action count for training models of affirmative actions.

Example 18. The computer-implemented system of any of the preceding examples, wherein the aggregate summary reports comprise hierarchically structured event-attributed affirmative action count as nodes distributed in a plurality of levels.

Example 19. A non-transitory computer-readable media encoded with a computer program, the computer program comprising instructions that when executed by one or more computers cause the one or more computers to perform operations comprising: receiving, by one or more processors from a configuration of an attribution reporting application programming interface (ARA), a sensitivity level of an application programming interface for collecting interaction data, the sensitivity level defining parameters of an interaction level monitored for collection of the interaction data; receiving, by the one or more processors from the configuration of the ARA, a maximum number of affirmative actions to be applied to the interaction data collected within the sensitivity level, the maximum number of affirmative actions defining a truncation applied to the affirmative actions; converting, by the one or more processors, the interaction data using the maximum number of affirmative actions to generate an affirmative action count; assigning, by the one or more processors, a scaling contribution to the affirmative action count to generate scaled data within particular units; aggregating, by the one or more processors, the scaled data by splitting the scaled data across a plurality of levels of an aggregate hierarchy of a targeted aggregate structure, to generate aggregated data; adding, by the one or more processors, noise to the aggregated data to generate noisy aggregated data; rescaling, by the one or more processors, the noisy aggregated data, using a scaling factor to generate rescaled data as aggregate summary reports, the aggregate summary reports being within a unit range set by the scaling factor; and transmitting, by the one or more processors, the rescaled data to determine use cases.

Example 20. The non-transitory computer-readable media of the preceding example, wherein the sensitivity level and the maximum number of affirmative actions affect a balance between the data accuracy and data privacy. What is claimed is:

1. A computer-implemented method comprising:
receiving, by one or more processors from a configuration of an attribution reporting application programming interface (ARA), a sensitivity level of an application programming interface for collecting interaction data, the sensitivity level defining parameters of an interaction level monitored for collection of the interaction data;
receiving, by the one or more processors from the configuration of the ARA, a maximum number of affirmative actions to be applied to the interaction data collected within the sensitivity level, the maximum number of affirmative actions defining a truncation applied to the affirmative actions;
converting, by the one or more processors, the interaction data using the maximum number of affirmative actions to generate an affirmative action count;
assigning, by the one or more processors, a scaling contribution to the affirmative action count to generate scaled data within particular units;
aggregating, by the one or more processors, the scaled data by splitting the scaled data across a plurality of levels of an aggregate hierarchy of a targeted aggregate structure, to generate aggregated data;
adding, by the one or more processors, noise to the aggregated data to generate noisy aggregated data;
rescaling, by the one or more processors, the noisy aggregated data, using a scaling factor to generate rescaled data as aggregate summary reports, the aggregate summary reports being within a unit range set by the scaling factor; and
transmitting, by the one or more processors, the rescaled data to determine use cases.

2. The computer-implemented method of claim 1, wherein the sensitivity level and the maximum number of affirmative actions affect a balance between the data accuracy and data privacy.

3. The computer-implemented method of claim 1, further comprising:
receiving, by the one or more processors from the configuration of the ARA, a many-per-click (MPC) limit defining a number of affirmative actions to be registered; and
truncating, by the one or more processors, the affirmative actions using the MPC limit.

4. The computer-implemented method of claim 1, wherein the noise comprises Laplace noise added to each data slice of the aggregated data.

5. The computer-implemented method of claim 1, wherein the noise is applied using a noising transformation that uses a set of summary statistics that index aspects of the affirmative actions type.

6. The computer-implemented method of claim 1, wherein an increase of the scaling factor decreases the noise.

7. The computer-implemented method of claim 6, wherein the increase of the scaling factor is limited by a limit defined by the configuration of the ARA.

8. The computer-implemented method of claim 1, further comprising:
using, by the one or more processors, the affirmative action count for training models of affirmative actions.

9. The computer-implemented method of claim 1, wherein the aggregate summary reports comprise hierarchically structured event-attributed affirmative action count as nodes distributed in a plurality of levels.

10. A computer-implemented system comprising:
memory storing application programming interface (API) information; and
a server performing operations comprising:
receiving, by one or more processors from a configuration of an attribution reporting application programming interface (ARA), a sensitivity level of an application programming interface for collecting interaction data, the sensitivity level defining parameters of an interaction level monitored for collection of the interaction data;
receiving, by the one or more processors from the configuration of the ARA, a maximum number of affirmative actions to be applied to the interaction data collected within the sensitivity level, the maximum number of affirmative actions defining a truncation applied to the affirmative actions;
converting, by the one or more processors, the interaction data using the maximum number of affirmative actions to generate an affirmative action count;
assigning, by the one or more processors, a scaling contribution to the affirmative action count to generate scaled data within particular units;
aggregating, by the one or more processors, the scaled data by splitting the scaled data across a plurality of levels of an aggregate hierarchy of a targeted aggregate structure, to generate aggregated data;
adding, by the one or more processors, noise to the aggregated data to generate noisy aggregated data;
rescaling, by the one or more processors, the noisy aggregated data, using a scaling factor to generate rescaled data as aggregate summary reports, the aggregate summary reports being within a unit range set by the scaling factor; and
transmitting, by the one or more processors, the rescaled data to determine use cases.

11. The computer-implemented system of claim 10, wherein the sensitivity level and the maximum number of affirmative actions affect a balance between the data accuracy and data privacy.

12. The computer-implemented system of claim 10, wherein the operations further comprise:
receiving, by the one or more processors from the configuration of the ARA, a many-per-click (MPC) limit defining a number of affirmative actions to be registered; and
truncating, by the one or more processors, the affirmative actions using the MPC limit.

13. The computer-implemented system of claim 10, wherein the noise comprises Laplace noise added to each data slice of the aggregated data.

14. The computer-implemented system of claim 10, wherein the noise is applied using a noising transformation that uses a set of summary statistics that index aspects of the affirmative actions type.

15. The computer-implemented system of claim 10, wherein an increase of the scaling factor decreases the noise.

16. The computer-implemented system of claim 15, wherein the increase of the scaling factor is limited by a limit defined by the configuration of the ARA.

17. The computer-implemented system of claim 10, wherein the operations further comprise:
using, by the one or more processors, the affirmative action count for training models of affirmative actions.

18. The computer-implemented system of claim 10, wherein the aggregate summary reports comprise hierarchically structured event-attributed affirmative action count as nodes distributed in a plurality of levels.

19. A non-transitory computer-readable media encoded with a computer program, the computer program comprising instructions that when executed by one or more computers cause the one or more computers to perform operations comprising:
receiving, by one or more processors from a configuration of an attribution reporting application programming interface (ARA), a sensitivity level of an application programming interface for collecting interaction data, the sensitivity level defining parameters of an interaction level monitored for collection of the interaction data;
receiving, by the one or more processors from the configuration of the ARA, a maximum number of affirmative actions to be applied to the interaction data collected within the sensitivity level, the maximum number of affirmative actions defining a truncation applied to the affirmative actions;
converting, by the one or more processors, the interaction data using the maximum number of affirmative actions to generate an affirmative action count;
assigning, by the one or more processors, a scaling contribution to the affirmative action count to generate scaled data within particular units;
aggregating, by the one or more processors, the scaled data by splitting the scaled data across a plurality of levels of an aggregate hierarchy of a targeted aggregate structure, to generate aggregated data;
adding, by the one or more processors, noise to the aggregated data to generate noisy aggregated data;
rescaling, by the one or more processors, the noisy aggregated data, using a scaling factor to generate rescaled data as aggregate summary reports, the aggregate summary reports being within a unit range set by the scaling factor; and
transmitting, by the one or more processors, the rescaled data to determine use cases.

20. The non-transitory computer-readable media of claim 19, wherein the sensitivity level and the maximum number of affirmative actions affect a balance between the data accuracy and data privacy.
